(19) United States
(12) Patent Application Publication
(10) Pub. No.: US 2016/0360550 A1
(43) Pub. Date: Dec. 8, 2016

(54) LOW LATENCY UNDER TIME DIVISION DUPLEX AND FLEXIBLE FREQUENCY DIVISION DUPLEX

(71) Applicant: QUALCOMM Incorporated, San Diego, CA (US)

(72) Inventors: Wanshi Chen, San Diego, CA (US); Shimman Arvind Patel, San Diego, CA (US); Peter Gaal, San Diego, CA (US); Yongbin Wei, La Jolla, CA (US); Hao Xu, San Diego, CA (US); Michael Mao Wang, San Diego, CA (US); Durga Prasad Malladi, San Diego, CA (US)

(21) Appl. No.: 15/140,322

(22) Filed: Apr. 27, 2016

Related U.S. Application Data
(60) Provisional application No. 62/170,205, filed on Jun. 3, 2015.

(51) Int. Cl. H04W 72/12; H04L 5/00; H04L 5/14

(52) U.S. Cl. CPC H04W 72/1294; H04W 72/1205; H04L 5/14; H04L 5/0005

(57) ABSTRACT

Methods, systems, and devices for wireless communication are described. A user equipment (UE) may operate in a system that supports operation with transmission time intervals (TTIs) of different durations. The UE may monitor for a grant during a first TTI and may determine the communication direction of a second TTI based on a received grant. The UE may re-determine the communication direction of the second TTI based, for example, on an explicit indication. In some examples, the UE may adapt uplink scheduling timing based on the indicator. In some examples, a UE may communicate in one direction during a TTI of a first duration and may communicate in a different direction during a TTI of the second duration that is within the TTI of the first duration.

### CROSS REFERENCES

The present Application for Patent claims priority to U.S. Provisional Patent Application No. 62/170,205 entitled “Low Latency Under Time Division Duplex and Flexible Frequency Division Duplex,” filed Jun. 3, 2015, assigned to the assignee hereof, and expressly incorporated by reference herein.

### BACKGROUND

The following relates generally to wireless communication, and more specifically to low latency operation under time division duplexing (TDD) and flexible frequency division duplexing (FDD).

Wireless multiple-access technologies have been adopted in various telecommunication standards to provide a common protocol that enables different wireless devices to communicate on a municipal, national, regional, and even global level. An example telecommunication standard is Long Term Evolution (LTE). LTE is designed to improve spectral efficiency, lower costs, improve services, make use of new spectrum, and better integrate with other open standards. LTE may use OFDMA on the downlink (DL), single-carrier frequency division multiple access (SC-FDMA) on the uplink (UL), and multiple-input multiple-output (MIMO) antenna technology

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., LTE). A wireless multiple-access communications system may include a number of base stations, each simultaneously supporting communication for multiple communication devices, which may be otherwise known as user equipment (UE).

In some cases, a wireless system may support low latency operations using transmission time intervals (TTI) of different durations. For instance, TTIs of one duration may be employed for communications that are not latency sensitive, while shorter duration TTIs may be used for latency sensitive communications. In some cases, low latency communications may be scheduled dynamically; but certain system configurations, including certain a time division duplexing (TDD) and frequency division duplexing (FDD) frame structures, may present challenges for effective low latency scheduling.

### SUMMARY

A user equipment (UE) may be configured for operation with transmission time intervals (TTIs) of multiple durations (e.g., some TTIs may be based on low latency operations); and the UE may employ various techniques to determine information about a system configuration without significant signaling overhead. For example, the UE may monitor for a grant during a first TTI and may determine the communication direction of a subsequent TTI based on a received grant (e.g., a DL grant may imply a future uplink hybrid automatic repeat request (HARD) response and an UL grant indicates a future uplink transmission more directly). The UE may also monitor for a direction indicator (e.g., an explicit signal) of the subsequent TTI. The indicator may be received during the first TTI or during an intermediate TTI. The UE may re-determine the communication direction of the second TTI based on the indicator. In some examples, the UE may determine a duplexing configuration of a frame where some of the TTIs having one duration may be configurable as one or more TTIs of the second duration. The UE may also receive a first downlink (DL) transmission during a TTI of the second duration that includes the portion of the UL TTI.

A method of wireless communication in a system configured for operation with TTIs of a first duration and TTIs of second duration that is less than the first duration is described. The method may include monitoring for a grant during a first TTI of the second duration, monitoring for an indicator of a communication direction of a second TTI of the second duration, and determining the communication direction of the second TTI based at least in part on whether the indicator is received and whether the grant is received during the first TTI.

A further method of wireless communication in a system configured for operation with TTIs of a first duration and TTIs of second duration that is less than the first duration, is described. The method may include determining a duplexing configuration of a frame comprising TTIs of the first duration, determining that at least a portion of an UL TTI of the frame is configurable as one or more TTIs of the second duration, and receiving a first DL transmission during a TTI of the second duration that comprises the portion of the UL TTI.

A further method of wireless communication in a system configured for operation with TTIs of a first duration and TTIs of second duration that is less than the first duration, is described. The method may include transmitting a grant to a first UE in a first TTI of the second duration, transmitting to the first UE an indicator of a communication direction of a second TTI of the second duration, and communicating with the first UE based at least in part on the grant and the indicator.

An apparatus for wireless communication in a system configured for operation with TTIs of a first duration and TTIs of second duration that is less than the first duration is also described. The apparatus may include means for monitoring for a grant during a first TTI of the second duration, means for monitoring for an indicator of a communication direction of a second TTI of the second duration, and means for determining the communication direction of the second TTI based at least in part on whether the indicator is received and whether the grant is received during the first TTI.

A further apparatus for wireless communication in a system configured for operation with TTIs of a first duration and TTIs of second duration that is less than the first duration described. The apparatus may include means for determining a duplexing configuration of a frame comprising TTIs of the first duration, means for determining that at least a portion of an UL TTI of the frame is configurable as one or more TTIs of the second duration, and means for receiving a first DL transmission during a TTI of the second duration that comprises the portion of the UL TTI.

A further apparatus for wireless communication in a system configured for operation with TTIs of a first duration and TTIs of second duration that is less than the first duration is described. The apparatus may include means for transmitting a grant to a first UE in a first TTI of the second duration, means for transmitting to the first UE an indicator of a communication direction of a second TTI of the second duration, and means for communicating with the first UE based at least in part on the grant and the indicator.

A further apparatus for wireless communication in a system configured for operation with TTIs of a first duration and TTIs of second duration that is less than the first duration is described. The apparatus may include means for identifying a first TTI having of the first duration and configured for transmission in a first direction, means for identifying a second TTI within the first TTI, the second TTI having the second duration and configured for transmission in second direction that is reverse from the first direction, and means for communicating in the first direction during the first TTI and the second direction during the second TTI.

A further apparatus for wireless communication in a system configured for operation with TTIs of a first duration and TTIs of second duration that is less than the first duration is described. The apparatus may include a processor, memory in electronic communication with the processor, and instructions stored in the memory and operable, when executed by the processor, to cause the apparatus to monitor for a grant during a first TTI of the second duration, monitor for an indicator of a communication direction of a second TTI of the second duration, and determine the communication direction of the second TTI based at least in part on whether the indicator is received and whether the grant is received during the first TTI.

A further apparatus for wireless communication in a system configured for operation with TTIs of a first duration and TTIs of second duration that is less than the first duration is described. The apparatus may include a processor, memory in electronic communication with the processor, and instructions stored in the memory and operable, when executed by the processor, to cause the apparatus to determine a duplexing configuration of a frame comprising TTIs of the first duration, determine that at least a portion of an UL TTI of the frame is configurable as one or more TTIs of the second duration, and receive a first DL transmission during a TTI of the second duration that comprises the portion of the UL TTI.

A further apparatus for wireless communication in a system configured for operation with TTIs of a first duration and TTIs of second duration that is less than the first duration is described. The apparatus may include a processor, memory in electronic communication with the processor, and instructions stored in the memory and operable, when executed by the processor, to cause the apparatus to transmit a grant to a first UE in a first TTI of the second duration, transmit to the first UE an indicator of a communication direction of a second TTI of the second duration, and communicate with the first UE based at least in part on the grant and the indicator.

A further apparatus for wireless communication in a system configured for operation with TTIs of a first duration and TTIs of second duration that is less than the first duration is described. The apparatus may include a processor, memory in electronic communication with the processor, and instructions stored in the memory and operable, when executed by the processor, to cause the apparatus to identify a first TTI having of the first duration and configured for transmission in a first direction, identify a second TTI within the first TTI, the second TTI having the second duration and configured for transmission in second direction that is reverse from the first direction, and communicate in the first direction during the first TTI and the second direction during the second TTI.

A non-transitory computer-readable medium storing code for wireless communication in a system configured for operation with transmission time intervals TTIs of a first duration and TTIs of second duration that is less than the first duration is also described. The code may include instructions executable to monitor for a grant during a first TTI of the second duration, monitor for an indicator of a communication direction of a second TTI of the second duration, and determine the communication direction of the second TTI based at least in part on whether the indicator is received and whether the grant is received during the first TTI.

A further non-transitory computer-readable medium storing code for wireless communication in a system configured for operation with transmission time intervals TTIs of a first duration and TTIs of second duration that is less than the first duration is described. The code may include instructions executable to determine a duplexing configuration of a frame comprising TTIs of the first duration, determine that at least a portion of an UL TTI of the frame is configurable as one or more TTIs of the second duration, and receive a first DL transmission during a TTI of the second duration that comprises the portion of the UL TTI.

A further non-transitory computer-readable medium storing code for wireless communication in a system configured for operation with transmission time intervals TTIs of a first duration and TTIs of second duration that is less than the first duration is also described. The code may include instructions executable to transmit a grant to a first UE in a first TTI of the second duration, transmit to the first UE an indicator of a communication direction of a second TTI of the second duration, and communicate with the first UE based at least in part on the grant and the indicator.

A further non-transitory computer-readable medium storing code for wireless communication in a system configured for operation with transmission time intervals TTIs of a first duration and TTIs of second duration that is less than the first duration is also described. The code may include instructions executable to identify a first TTI having of the first duration and configured for transmission in a first direction, identify a second TTI within the first TTI, the second TTI having the second duration and configured for transmission in second direction that is reverse from the first direction, and communicate in the first direction during the first TTI and the second direction during the second TTI.

Some examples of the method, apparatus, or non-transitory computer-readable medium described above may further include processes, features, means, or instructions for receiving the grant during the first TTI based at least in part on monitoring for the grant, where the communication direction of the second TTI is determined based at least in part on the received grant and a hybrid automatic repeat request (HARD) timing or uplink (UL) scheduling timing.

Some examples of the method, apparatus, or non-transitory computer-readable medium described above may further include processes, features, means, or instructions for receiving the indicator during the first TTI or a subsequent TTI based at least in part on monitoring for the indicator and re-determining the communication direction of the second TTI based at least in part on the received indicator. Some examples of the method, apparatus, or non-transitory computer-readable medium described above may further include processes, features, means, or instructions for adapting the HARQ timing or the UL scheduling timing, or both, based at least in part on receiving the indicator.

Some examples of the method, apparatus, or non-transitory computer-readable medium described above may further include processes, features, means, or instructions for determining that a duration comprises a guard period, where the guard period determination is based at least in part on the grant, HARQ timing, UL scheduling timing, or the indicator, or any combination thereof.

Some examples of the method, apparatus, or non-transitory computer-readable medium described above may further include processes, features, means, or instructions for receiving the indicator during the first TTI or a subsequent TTI of the second duration based at least in part on monitoring for the indicator and determining that no grant is received during the first TTI based at least in part on monitoring for the grant, where the communication direction of the second TTI is determined based at least in part on the received indicator.

Some examples of the method, apparatus, or non-transitory computer-readable medium described above may further include processes, features, means, or instructions for refraining from monitoring at least one TTI of the second TTI duration based at least in part on the received indicator and the determined communication direction of the second TTI. In some examples of the method, apparatus, or non-transitory computer-readable medium described above, the indicator comprises a physical control channel.

In some examples of the method, apparatus, or non-transitory computer-readable medium described above, the communication direction of the second TTI is determined based at least in part on a carrier type, a subframe type, or reference signal time-domain pattern.

In some examples of the method, apparatus, or non-transitory computer-readable medium described above, the carrier type comprises of at least one of a carrier operated in a licensed spectrum or a carrier operated in a contention-based spectrum, and the subframe type comprises at least one of a multicast broadcast single frequency network (MB SFN) subframe, a special subframe, or a downlink subframe. In some examples of the method, apparatus, or non-transitory computer-readable medium described above, the indicator designates a communication direction for a set of TTIs comprising the second TTI.

Some examples of the method, apparatus, or non-transitory computer-readable medium described above may further include processes, features, means, or instructions for receiving the indicator in the first TTI based at least in part on monitoring for the indicator, where the set of TTIs comprises a third TTI of the second duration after the second TTI.

Some examples of the method, apparatus, or non-transitory computer-readable medium described above may further include processes, features, means, or instructions for identifying a communication direction of a third TTI, the third TTI having the first duration, where the second TTI is within the third TTI, determining that the communication direction of the second TTI is reverse from the communication direction of the third TTI, and communicating in the communication direction of the second TTI during the second TTI.

Some examples of the method, apparatus, or non-transitory computer-readable medium described above may further include processes, features, means, or instructions for communicating an indication of the presence of the second TTI within the first TTI, where the communication during the second TTI is based at least in part on the indication.

Some examples of the method, apparatus, or non-transitory computer-readable medium described above may further include processes, features, means, or instructions for identifying a duration within the first TTI, where the duration comprises a guard period. In some examples of the method, apparatus, or non-transitory computer-readable medium described above, the resources of the second TTI are frequency division multiplexing (FDM) with resources of the first TTI.

Some examples of the method, apparatus, or non-transitory computer-readable medium described above may further include processes, features, means, or instructions for determining a traffic condition of the first UE and a second UE within the system and transmitting the indicator based at least in part on traffic associated with the first UE or the second UE. In some examples of the method, apparatus, or non-transitory computer-readable medium described above, the indicator is transmitted during the first TTI or a subsequent TTI.

### BRIEF DESCRIPTION OF THE DRAWINGS

Aspects of the disclosure are described in reference to the following figures:

FIG. 1 illustrates an example of a wireless communications system that supports low latency under time division duplex (TDD) and flexible frequency division duplex (FDD) in accordance with various aspects of the present disclosure;

FIG. 2 illustrates an example of a wireless communications system that supports low latency under TDD and flexible FDD in accordance with various aspects of the present disclosure;

FIG. 3 illustrates an example frame configuration that supports low latency under TDD in accordance with various aspects of the present disclosure;

FIGS. 4A and 4B illustrate examples of TTI configurations that support low latency under TDD in accordance with various aspects of the present disclosure;

FIGS. 5A and 5B illustrate examples of frame configurations that support low latency under TDD and flexible FDD in accordance with various aspects of the present disclosure;

FIG. 6 illustrates an example of a process flow in a system that supports low latency under TDD and flexible FDD in accordance with various aspects of the present disclosure;

FIGS. 7-9 show block diagrams of a wireless device or devices that support low latency under TDD and flexible FDD in accordance with various aspects of the present disclosure;

FIG. 10 illustrates a block diagram of a system, including a user equipment (UE) that, supports low latency under TDD and flexible FDD in accordance with various aspects of the present disclosure;

FIGS. 11-13 show block diagrams of a wireless device or devices that support low latency under TDD and flexible FDD in accordance with various aspects of the present disclosure;

FIG. 14 illustrates a block diagram of a system, including a base station, that supports low latency under TDD and flexible FDD in accordance with various aspects of the present disclosure; and

FIGS. 15-20 illustrate methods for low latency under TDD and flexible FDD in accordance with various aspects of the present disclosure.

### DETAILED DESCRIPTION

Some wireless systems may utilize low latency operations in which transmission time intervals (TTI) may have a reduced duration as compared with other TTIs in the system or TTIs of certain legacy systems. In some cases, low latency operation may result in a significant over-the-air latency reduction. But due to backward compatibility constraints and subframe configurations, supporting low latency may introduce scheduling complexity. For example, for both time division duplexing (TDD) and frequency division duplexing (FDD) frame configurations of longer duration TTI (e.g., subframes), scheduling low latency (e.g., short duration) TTIs may be complicated. That is, in some cases, to achieve backward compatibility, shorter duration TTIs in a particular frame structure may be scheduled to mitigate disruptions to longer duration TTIs in the frame structure, which may affect scheduling to meet the needs of low latency traffic.

The management of communication directions of low latency TTIs (e.g., uplink (UL) or downlink (DL)) may be done within the confines of, or in consideration of, legacy TTI communication direction. Moreover, a number of other factors, including uplink control information (UCI) for low latency traffic may be accounted for, including hybrid automatic repeat request (HARQ) responses, scheduling requests, channel state information feedback, and the like.

In some cases, a transmission direction may be indicated by a physical layer control channel, e.g., in enhanced interference mitigation and traffic adaptation (eIMTA) schemes. But for low latency operation, the management of a symbol for UL and low latency DL may take into account both traffic needs and latency needs. For example, there may be heavy traffic in DL with low quality of service (QoS) and light traffic in UL with high QoS, or vice versa. In such cases, while a majority of symbols may be DL, a small set of symbols may be allocated for low latency UL, which may be urgent. As a result, an eIMTA-like indication of DL/low latency UL configuration for a relatively long duration, such as greater than 1 ms, for example, may be less effective than the effective than the mixture of explicit signaling and blind detection described herein.

In other words, to accommodate potentially rapid changes in demands of low latency traffic, and to account for other system constraints in without significantly increasing signaling overhead, the determination of DL/low latency UL TTIs may be based on a mixture of explicit signaling and blind detection. For instance, a UE may assume that a TTI is a low latency DL TTI and may then determine the actual TTI direction based on an explicit signaling and scheduling or configuration decision. If an uplink or downlink grant is received, for example, the UE may implicitly determine that an UL TTI will follow after a certain period of time following the grant (e.g., based on HARQ timing, UL timing, etc.). In some cases, the UE may confirm whether the TTI is UL or DL by receiving an explicit signal from a base station (e.g., at the same time as a grant, at a predefined period prior to the TTI in question, etc.).

In some cases, DL HARQ timing or UL scheduling timing may be adapted in response to explicit signaling. For example, a previously schedule UL transmission may be delayed to subsequent symbol in response to explicit signaling. A guard period, which may be used for DL-to-low latency UL switching may also be implicitly derived based on the explicit signaling, scheduling, or an indicated configuration.

In both TDD and flexible FDD, certain subframes (or other TTIs) may be conducive to flexible operation; for example low latency UL traffic may readily be sent in an UL subframe. Additionally or alternatively, a fraction of available resources of an UL subframe of either a TDD or FDD may be used for certain transmission, while the remaining resources of the UL subframe may be used for low latency DL transmissions, for instance. In some examples, grouping UL traffic to concentrate the transmissions over a smaller duration may be useful for managing low latency traffic. This may likewise be done for DL traffic.

By way of example, low latency traffic may also be scheduled at the same time as non-low-latency (e.g., legacy) traffic. When this happens, low latency traffic may be delayed to the next subframe. Alternatively, low latency may puncture non-low-latency traffic. The puncturing may be done such that low latency only punctures non-DMRS symbols, for instance, thus limiting disruption to non-low-latency traffic. In other examples, low latency and non-low-latency traffic may be frequency division multiplexed (FDM), which may likewise limit disruption to non-low-latency transmissions.

Aspects of the disclosure are further described below in the context of a wireless communication system. Specific examples are then described for direction indication timing and for flexible TTI structures, including TDD and FDD. These and other aspects of the disclosure are further illustrated by and described with reference to apparatus diagrams, system diagrams, and flowcharts that relate to low latency under TDD and flexible FDD.

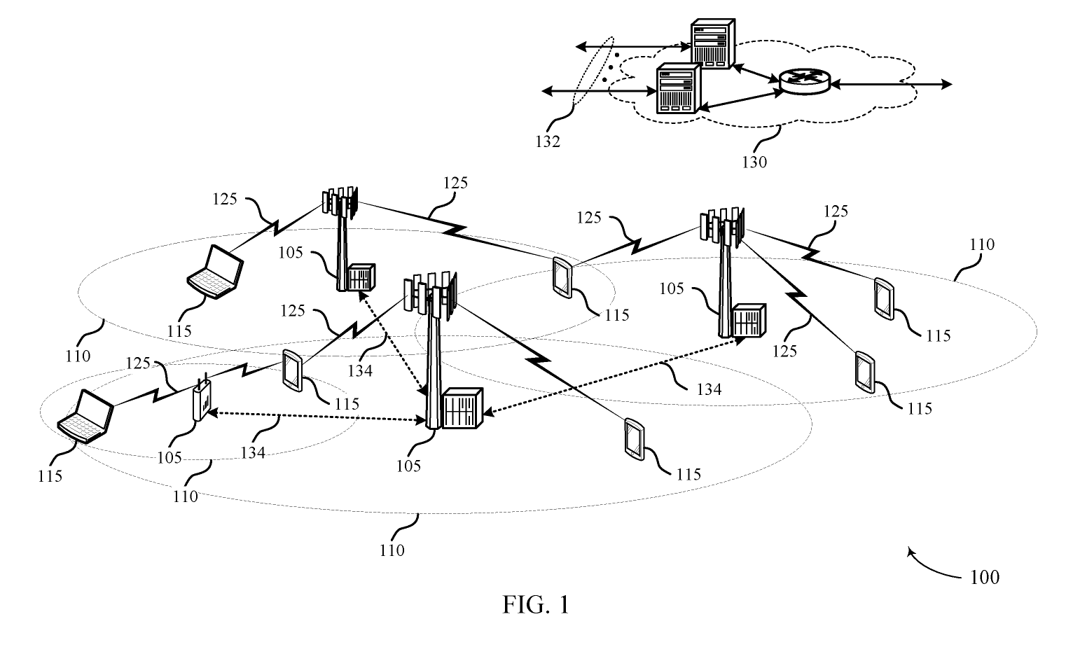

FIG. 1 illustrates an example of a wireless communications system 100 in accordance with various aspects of the present disclosure. The wireless communications system 100 includes base stations 105, user equipment (UEs) 115, and a core network 130. In some examples, the wireless communications system 100 may be a Long Term Evolution (LTE)/LTE-Advanced (LTE-A) network. Wireless communications system 100 may illustrate an example of a system in which UEs 115 are configured to perform both uplink and downlink transmissions within a single subframe (e.g., if a low latency transmission time interval (TTI) is less than a subframe). Thus, as explained further below, a UE 115 may determine the direction of a future TTI based on received UL and DL grants, and may also receive a direction indicator from a base station 105.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

UEs 115 may be dispersed throughout the wireless communications system 100, and each UE 115 may be stationary or mobile. A UE 115 may also be referred to as a mobile station, a subscriber station, a remote unit, a wireless device, an access terminal, a handset, a user agent, a client, or some other suitable terminology. A UE 115 may also be a cellular phone, a wireless modem, a handheld device, a personal computer, a tablet, a personal electronic device, a machine type communication (MTC) device or the like.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. Each communication link 125 may include one or more carriers, where each carrier may be a signal made up of multiple sub-carriers (e.g., waveform signals of different frequencies) modulated according to the various radio technologies described herein. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources), as described below. Frame structures may be defined for FDD (e.g., frame structure type 1) and TDD (e.g., frame structure type 2). Some communication links 125 may include a TDD carrier or TDD carriers configured with or capable of scheduling as flexible subframes, as described below.

Time intervals in LTE/LTE-A may be expressed in multiples of a basic time unit (e.g., the sampling period, Ts= 1/30,720,000 seconds). Time resources may be organized according to radio frames of length of 10 ms (Tf=307200−Ts), which may be identified by a system frame number (SFN) ranging from 0 to 1023. Each frame may include ten 1 ms subframes numbered from 0 to 9. A subframe may be further divided into two 0.5 ms slots, each of which contains 6 or 7 modulation symbol periods (depending on the length of the cyclic prefix prepended to each symbol). Excluding the cyclic prefix, each symbol contains 2048 sample periods. In some cases the subframe may be the smallest scheduling unit, also known as a TTI. In other cases, including for systems that support low latency operation, a TTI may be shorter than a subframe or may be employed (e.g., in short TTI bursts or in selected component carriers using short TTIs). In some cases, a symbol may be the smallest TTI, where each TTI may be either an uplink or downlink communication. The system 100 may support UE 115 operation with TTIs of different durations—in such systems, longer duration TTI may be referred to as legacy TTIs and shorter duration TTIs may be referred to as low latency TTIs. UE 115 may be configured to determine the communication direction of a second TTI based on a received grant in a first TTI. In other cases, UE 115 may receive an indicator of the communication direction of the second TTI from base station 105.

The system 100 may be a packet-based network that operates according to a layered protocol stack and data in the user plane may be based on the IP. A radio link control (RLC) layer of the protocol stack may perform packet segmentation and reassembly to communicate over logical channels. A medium access control (MAC) layer may perform priority handling and multiplexing of logical channels into transport channels. The MAC layer may also use hybrid automatic repeat request (HARQ) to provide retransmission at the MAC layer to improve link efficiency. In the control plane, the radio resource control (RRC) protocol layer may provide establishment, configuration, and maintenance of an RRC connection between a UE 115 and the base stations 105. RRC signaling may be used to configure various UEs 115 for communication via one or several carriers, for example. The RRC protocol layer may also be used for core network 130 support of radio bearers for the user plane data. At the physical (PHY) layer, transport channels may be mapped to physical channels.

HARQ, as mentioned, may improve link efficiency by attempting to ensure that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., signal-to-noise conditions). In Incremental Redundancy HARQ, incorrectly received data may be stored in a buffer and combined with subsequent transmissions to improve the overall likelihood of successfully decoding the data. In some cases, redundancy bits are added to each message prior to transmission. This may be especially useful in poor conditions. In other cases, redundancy bits are not added to each transmission, but are retransmitted after the transmitter of the original message receives a negative acknowledgement (NACK) indicating a failed attempt to decode the information. The chain of transmission, response and retransmission may be referred to as a HARQ process. In some cases, a limited number of HARQ processes may be used for a given communication link 125. In some cases, a UE 115 may receive a grant during a first TTI and may determine the communication direction of a second TTI based on HARQ timing.

DL PHY layer channels may include physical broadcast channel (PBCH) for broadcast information, physical control format indicator channel (PCFICH) for control format information, physical frame format indicator channel (PFFICH) for frame format information (e.g. in contention based spectrum), physical downlink control channel (PDCCH) for control and scheduling information, physical HARQ indicator channel (PHICH) for HARQ status messages, physical downlink shared channel (PDSCH) for user data and physical multicast channel (PMCH) for multicast data. UL physical channels may include physical random access channel (PRACH) for access messages, physical uplink control channel (PUCCH) for control data, and physical uplink shared channel (PUSCH) for user data.

PDCCH may carry downlink control information (DCI) in control channel elements (CCEs), which may consist of nine logically contiguous resource element groups (REGs), where each REG contains 4 resource elements (REs). DCI includes information regarding downlink (DL) scheduling assignments, uplink (UL) resource grants, transmission scheme, UL power control, HARQ information, modulation and coding scheme (MCS) and other information. The size and format of the DCI messages can differ depending on the type and amount of information that is carried by the DCI. For example, if spatial multiplexing is supported, the size of the DCI message is large compared to contiguous frequency allocations. Similarly, for a system that employs multiple input multiple output (MIMO), the DCI must include additional signaling information. DCI size and format depend on the amount of information as well as factors such as bandwidth, the number of antenna ports, and duplexing mode. DCI may also indicate the subframe communication direction. However, UE 115 may be configured to determine the communication direction of low latency TTIs within a subframe.

PDCCH can carry DCI messages associated with multiple users, and each UE 115 may decode the DCI messages that are intended for it. For example, each UE 115 may be assigned a cell radio network temporary identity (C-RNTI) and CRC bits attached to each DCI may be scrambled based on the C-RNTI. To reduce power consumption and overhead at the user equipment, a limited set of CCE locations can be specified for DCI associated with a specific UE 115. CCEs may be grouped (e.g., in groups of 1, 2, 4 and 8 CCEs), and a set of CCE locations in which the user equipment may find relevant DCI may be specified. These CCEs may be known as a search space. The search space can be partitioned into two regions: a common CCE region or search space and a UE-specific (dedicated) CCE region or search space. The common CCE region is monitored by all UEs served by a base station 105 and may include information such as paging information, system information, random access procedures and the like. The UE-specific search space may include user-specific control information. CCEs may be indexed, and the common search space may start from CCE 0. The starting index for a UE specific search space depends on the C-RNTI, the subframe index, the CCE aggregation level and a random seed. A UE 115 may attempt to decode DCI by performing a process known as a blind decode, during which search spaces are randomly decoded until the DCI is detected. During a blind decode, the UE 115 may attempt descramble all potential DCI messages using its C-RNTI, and perform a CRC check to determine whether the attempt was successful.

PUCCH may be used for UL acknowledgements (ACKs), scheduling requests (SRs) and channel quality indicators (CQI) and other UL control information. A physical PUCCH may be mapped to a control channel defined by a code and two consecutive resource blocks. UL control signaling may depend on the presence of timing synchronization for a cell. PUCCH resources for scheduling request (SR) and channel quality indicator (CQI) reporting may be assigned (and revoked) through radio resource control (RRC) signaling. In some cases, resources for SR may be assigned after acquiring synchronization through a random access channel (RACH) procedure. In other cases, an SR may not be assigned to a UE 115 through the RACH (i.e., synchronized UEs may or may not have a dedicated SR channel). PUCCH resources for SR and CQI may be lost when the UE 115 is no longer synchronized. UE 115 may be configured to determine the communication direction of TTIs within a subframe based on UL scheduling timing.

In some cases, wireless communications system 100 may utilize one or more enhanced component carriers (eCCs), which may be represented by communication link 125. An enhanced component carrier (eCC) may be characterized by one or more features including: flexible bandwidth, different TTIs, and modified control channel configuration. In some cases, an eCC may be associated with a carrier aggregation (CA) configuration or a dual connectivity configuration (e.g., when multiple serving cells have a suboptimal backhaul link). An eCC may also be configured for use in unlicensed spectrum or shared spectrum (e.g., where more than one operator is licensed to use the spectrum). An eCC characterized by flexible bandwidth may include one or more segments that may be utilized by UEs 115 that are not capable of monitoring the whole bandwidth or prefer to use a limited bandwidth (e.g., to conserve power).

In some cases, an eCC may utilize a different TTI length than other component carriers (CCs), which may include use of a reduced or variable symbol duration as compared with TTIs of the other CCs. The symbol duration may remain the same, in some cases, but each symbol may represent a distinct TTI. In some examples, an eCC may include multiple hierarchical layers associated with the different TTI lengths. For instance, an eCC may utilize low latency TTIs, as discussed above. In some cases, a shorter symbol duration may also be associated with increased subcarrier spacing. In conjunction with the reduced TTI length, an eCC may utilize dynamic time division duplex (TDD) operation (i.e., it may switch from DL to UL operation for short bursts according to dynamic conditions.)

Flexible bandwidth and variable TTIs may be associated with a modified control channel configuration (e.g., an eCC may utilize an enhanced physical downlink control channel (ePDCCH) for DL control information). For example, one or more control channels of an eCC may utilize FDM scheduling to accommodate flexible bandwidth use. Other control channel modifications include the use of additional control channels (e.g., for evolved multimedia broadcast multicast service (eMBMS) scheduling, or to indicate the length of variable length UL and DL bursts), or control channels transmitted at different intervals. An eCC may also include modified or additional HARQ related control information.

Thus, a UE-115 may be configured for operation with TTIs of a first and second duration. The UE 115 may monitor for a grant during a first TTI and may determine the communication direction of a second TTI based on a received grant. The UE 115 may also monitor for a direction indicator of the second TTI and may receive the indicator during the first TTI or a subsequent TTI. The UE 115 may re-determine the communication direction of the second TTI based on the indicator. In some examples, the UE 115 may determine a duplexing configuration of a frame where at least a portion of an UL TTI of the frame may be configurable as one or more TTIs of the second duration. The UE may also receive a first DL transmission during a TTI of the second duration that includes the portion of the UL TTI.

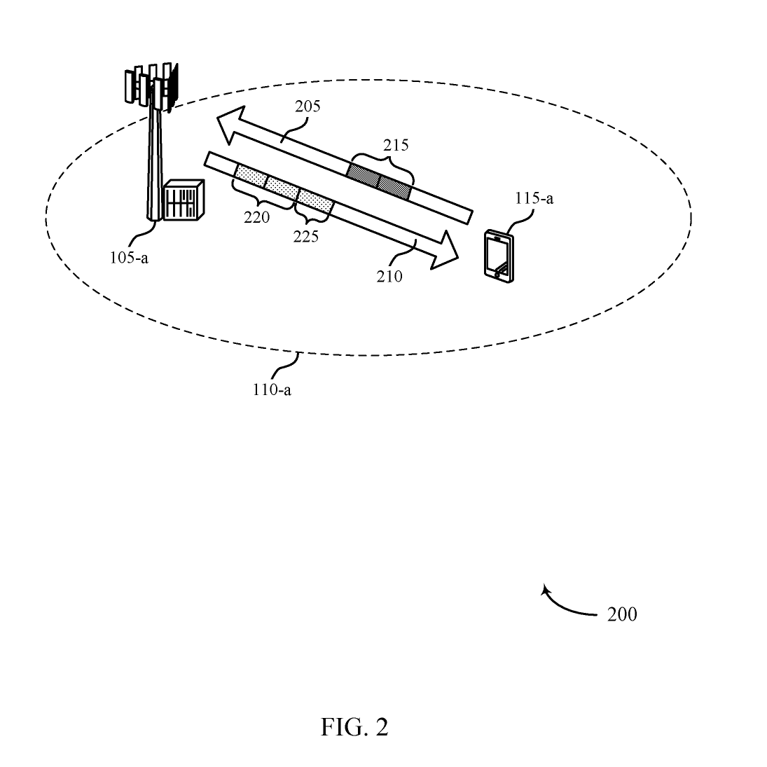

FIG. 2 illustrates an example of a wireless communications system 200 for low latency under TDD and flexible FDD in accordance with various aspects of the present disclosure. Wireless communications system 200 may include a UE 115-a and base station 105-a, which may be examples of a UE 115 base station 105 described with reference to FIG. 1. UE 115-a may communicate with base station 105-a through uplink communication 205 and downlink communication 210. As described herein, both uplink communication 205 and downlink communication 210 may occur during different TTIs within the same subframe. TTI 215 may represent a UL TTI and TTIs 220 and TTIs 225 may represent DL TTIs.

Based on the potential for both UL and DL TTIs within a subframe, and because the transmission direction may be dynamically scheduled by base station 105-a, UE 115-a may not be aware of whether an upcoming TTI is going to be an UL TTI or a DL TTI. Thus, in some cases UE 115-a may monitor each TTI as if it might contain a DL control or data transmission; and UE 115-a may check that assumption against implicit or explicit signaling. For example, UE 115-a may receive a grant and determine—e.g., based on HARQ timing (for a DL grant) or UL scheduling timing (for an UL grant)—that a subsequent TTI is an UL TTI. Additionally or alternatively, UE 115-a may receive explicit signaling of the transmission direction at a predetermined time period prior to a given TTI. In some cases, if UE 115-a determines that a TTI is an UL TTI, based on either explicit or implicit signaling, UE 115-a may refrain from monitoring during the TTI in order to conserve power (or, in some cases, it may transmit UL data).

As mentioned, reduced TTI durations may be designed to reduce latency between DL and UL transmissions. For example, in some wireless systems, a HARQ response time may take as long as 4 ms, whereas some low latency systems may complete HARQ in hundreds of microseconds. In some cases, such as in the example of wireless communications system 200, a low latency TTI may correspond to one LTE symbol period or approximately 71 μs for normal cyclic prefix (CP) and approximately 83 μs for extended CP. But other TTI lengths are possible (e.g., two LTE symbol periods, 1 slot, etc.).

Due to backward compatibility constraints and certain TDD DL or UL subframe configurations, supporting low latency under TDD may, as described above, introduce complexity. Subframe configurations may be indicated with, for instance, a system information broadcast (e.g., system information block Type 1 (SIB 1)); but certain UEs 115 may recognize and use DL and UL subframes as flexible subframes, configured for low latency operation. Such use may be subject to cell-specific reference signal (CRS) symbols, guard periods (GP), or control regions for other network operation. Although, CRS may not be present in certain subframe types, e.g., multi-broadcast single-frequency network (MBSFN) subframes; and such subframes may be readily leveraged for low latency operation. In some cases, and as described further below, UL subframes or special subframes may provide additional flexibility for DL/low latency UL arrangements.

The direction of low latency TTI (DL/UL) may be determined based on a mixture of receiving grants and by receiving a transmission direction indicator. A UE 115-a may assume that a symbol is a low latency DL symbol, but may determine (or confirm an) a symbol direction based on a received indicator and scheduling or configuration parameters. If, for instance, UE 115-a receives a DL grant or a UL grant in symbol n, it may determine the direction of symbol (n+k) based on the grant in symbol n. The timing k may depend on HARQ timing in the case of DL grants or, in the case of UL grants, may depend on UL scheduling timing, and may be different for UL or DL. In some cases, UE 115-a may detect explicit signaling from base station 105-a indicating whether (n+k) is a DL or low latency UL symbol. This indication may be received at symbol n or at another symbol (n+m) such that m<k. For example, if m=k−2 it may be such that it takes two symbols to receive and decode the indicator signal. In some cases, no such signaling may be detected and UE 115-a may determine that the second symbol is a low latency UL symbol. In general, the received indicator may take precedence over the implicit determination, or UL/DL grant driven determination. In some cases, UE 115-a may refrain from monitoring the symbols determined as low latency UL symbols. This may, for example, save battery power for UE 115-a.

The received indicator may be a layer 1 signaling, such as a PCFICH, in some cases. The signaling may be UE-specific, cell-specific, or group-specific. By way of example, the signaling may be dedicated signaling, groupcast signaling, or broadcast signaling. Without detection of the indicator, UE 115-a may determine a symbol direction based on the scheduling decisions or scheduling configurations. This may be subject to some constraints, such as when the CRS symbol is always a low latency DL symbol.

The received indicator may indicate the low latency direction for one or more symbols and may also indicate directions for some symbols immediately following. For example, a received indicator in symbol n may indicate symbol directions for n+2, n+3, and n+4. This may give some indication for UE 115-a to skip some symbols, for example, to save battery power, while placing less restriction on base station 105-a.

As mentioned, low latency traffic management, an implicit determinations related to communication direction, may be based on HARQ responses, where there may be both a minimum and maximum gap between a transmission and the corresponding HARQ ACK. For example, a minimum gap may be four symbols and the maximum gap may be 1 ms. Furthermore, a low latency PUCCH or PUSCH may have limited payload sizes that may place a constraint on the number of pending low latency DL transmissions. Other considerations may include the UL scheduling timing gap (a gap between a UL grant and the corresponding UL transmission). For example, this gap may be greater than or equal to four symbols. The DL HARQ timing and UL scheduling timing may be the same or different. For example, a four symbol gap may be used for both cases, or a four symbol gap may be used for DL HARQ timing but a three symbol gap for UL scheduling timing.

In some cases, DL HARQ timing or UL scheduling timing may be adapted in response to the received indicator. For example, it may be delayed to the next symbol, or the timing may be derived based on the received indicator or directly indicated by the received indicator. In some instances, a guard period may be implemented for DL to low latency UL switching and vice versa. This may be determined based on the received indicator, scheduling/configuration from base station 105-a, or directly indicated.

In some cases such as in TDD or flexible FDD, it is possible that ongoing legacy (i.e., non-low-latency) UL traffic may be interrupted by low latency DL traffic, ongoing legacy DL traffic may be interrupted by low latency DL traffic, or ongoing legacy DL traffic may be interrupted by low latency UL traffic. In one example, UE 115-a may delay certain legacy UL traffic to the next subframe where low latency may increase.

Or, in some cases, low latency traffic may puncture the legacy traffic. This may be done in a manner that is transparent to UE 115-a—e.g., where legacy traffic is UL traffic. Here, base station 105-a may determine the presence of overlapping transmission and may process the legacy UL traffic accordingly. If the legacy traffic is DL, base station 105-a may indicate to UE 115-a the presence of low latency traffic of a different direction. If the legacy traffic and the low latency traffic are for the same UE, a guard period may be necessary for TX/RX and RX/TX switching. The puncturing may be done for non-DMRS symbols, such that low latency punctures non-DMRS symbols such that the legacy traffic still may decode.

In other case, low latency and latency traffic may be FDM. For example, legacy traffic may occur in one direction and low latency may occur in a different direction in the same symbol period, but in different RBs, where a guard band may be employed to isolate mutual interference.

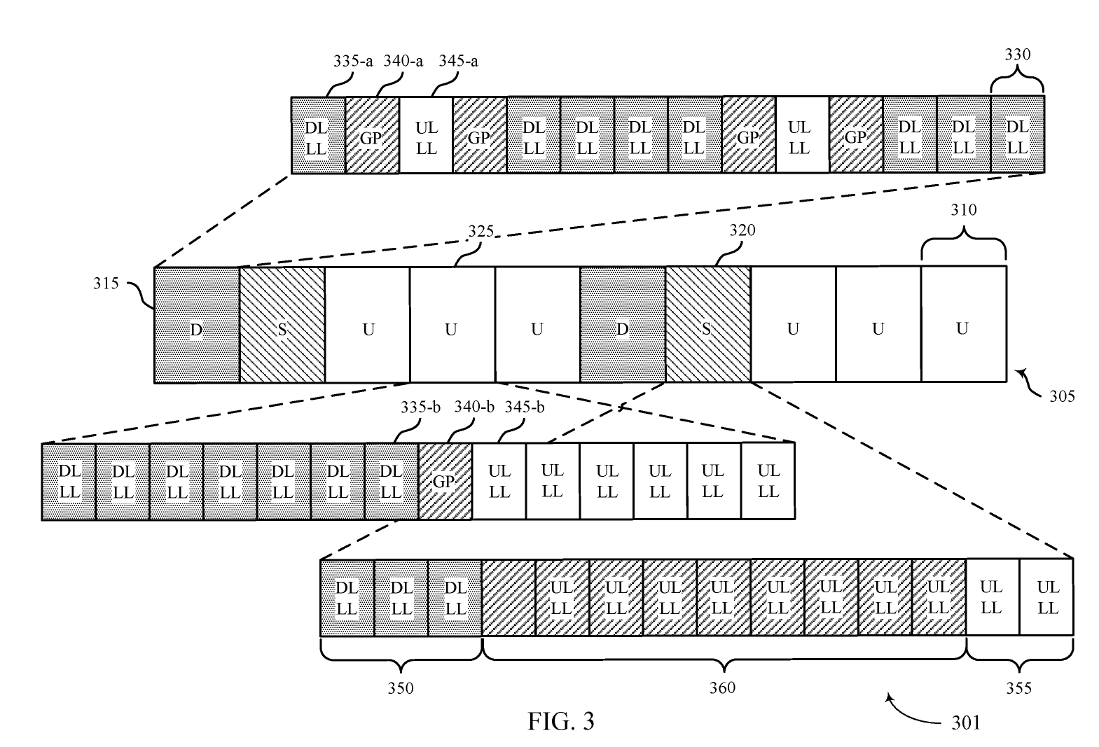

FIG. 3 illustrates an example of an expanded view of a frame configuration 300 for low latency under TDD and flexible FDD in accordance with various aspects of the present disclosure. Frame configuration 300 may include a frame 305, which may include a number of subframes 310 scheduled for downlink or uplink. Subframes 310 may be an example of TTIs 225 as described with reference to FIG. 2. Frame 305 may be used in a TDD or flexible FDD system.

Frame 305 may include a number of downlink subframes 315 and uplink subframes 325 that are configurable for or otherwise support low latency operation. In some cases, frame 305 may include both subframes that support low latency operations and purely legacy subframes. The distribution of downlink subframes 315 and uplink subframes 325 may be determined by a base station 105 according to predefined uplink/downlink TDD configurations. For example, frame 305 may have a configuration similar to LTE/LTE-A TDD Configuration 0, a configuration in which the first and seventh subframes are configured for downlink and the third, fourth, fifth, eighth, ninth, and tenth subframes are configured for uplink. Between the downlink subframes 315 and the uplink subframes 325, the base station may not schedule any information. Such scheduling gaps may allow a UE 115 to transition from a downlink setup to an uplink setup. Thus, frame 305 may include special subframes 320 which act as guard periods for occasions when communication direction changes (e.g., from downlink to uplink).

Subframes 310 may be partitioned into smaller segments—e.g., larger TTIs, such as slots, may include smaller TTIs, such as symbols. For example, subframes 310 may include a number of low latency symbols 330 (e.g., low latency TTIs). The low latency symbols 330 may be scheduled to convey downlink data (e.g., downlink symbols) or uplink data (e.g., uplink symbols). In some low-latency configurations, a base station 105 may schedule the low latency symbols 330 of a subframe 310 according to the same or different direction as the subframe 310. For example, downlink subframe 315 may include both low latency downlink symbols 335-a and low latency uplink symbols 345-a, and uplink subframe 325 may include both low latency downlink symbols 335-b and low latency uplink symbols 345-b. Because both low latency uplink symbols 345 and low latency downlink symbols 335 may be present in a subframe 310, a HARQ process may be performed during subframe 310. For example, a base station 105 may transmit data during low latency downlink symbol 335-a and receive an ACK/NACK for the data conveyed during low latency downlink symbol 335-a in low latency uplink symbol 345-a. Thus, a HARQ process may be performed at the symbol-level (e.g., within a subframe 310).

A base station 105 may schedule portions of some TTIs (e.g., subframes 310 or low latency symbols 330) for neither uplink nor downlink communications. The gap in scheduled communications may provide time for a UE 115 to change from a reception state to a transmission state, or vice versa. The gap may also help mitigate interference to reception from transmissions from another node. For instance, a base station 105 may refrain from scheduling communications during some symbols in a special subframe 320. Thus, during special subframe 320, a UE 115 may reconfigure communication states—e.g., the UE 115 may change from a reception configuration to a transmission configuration, etc. In some cases, these set of symbols in a special subframe 320 may be termed a guard period. According to the present disclosure, a base station 105 may schedule a number of low latency symbols 330 for communication within a special subframe 320 while refraining from scheduling some other low latency symbols 330. Thus, a fraction (e.g., one low latency symbol 330 or a fraction of one low latency symbol 330) of a special subframe 320 may be used for switching time. In other words, instead of the switching frequency at the subframe-level, symbol-level switching frequency may be implemented for a UE 115. For instance, a downlink partial transmission scheme (DwPTS) portion 350 may be defined for the first several symbols of special subframe 320, and the symbols of DwPTS portions 350 may be scheduled for low latency DL. Likewise, an uplink partial transmission scheme (UpPTS) portion 355 may be defined for the last several symbols of the special subframe 320, the symbols of the UpPTS portion 355 may be schedule for low latency UL.

Additionally, as illustrated in the example depicted in FIG. 3, all but one symbol of a guard period 360 of special subframe 320 may also be scheduled for low latency (e.g., low latency UL transmission). As another example, although not shown, at least one symbol of a guard period 360 of special subframe 320 may also be scheduled for low latency DL, while at least one symbol of a guard period 360 of special subframe 320 may also be scheduled for low latency UL. Switching periods may be implemented within special subframe 320, where each switching period may be placed between a transition from low latency DL or low latency UL, or vice versa. The duration of each switching period may be in units of symbols or in a fraction of symbol. The duration of each switching period may or may not be the same.

Different UEs 115 may process a special subframe 320 differently. Some UEs 115 may treat a special subframe 320 as a black box—e.g., ignoring information associated with low latency symbols 330 within the special subframe 320—while other UEs 115 may treat the special subframe as a transparent box—e.g., recognizing and processing information associated with low latency symbols 330 within special subframe 320. In other words, some UEs 115 may not recognize low latency symbols 330 which are scheduled to convey information within special subframe 320.

In some cases, a base station 105 may schedule gaps between communication direction changes at the symbol-level (e.g., the gaps may be within a subframe 310). For example, a base station 105 may schedule guard periods 340-a and 340-b, which may allow a UE 115 to change configurations. The guard periods 340 maybe the same length as the low latency symbols 330, or they may be fractions of the length of the low latency symbols 330. Additionally, the fractional-length guard periods 340 may have the same or different lengths. In some examples, a number of alternating DL or low latency UL periods may be scheduled within a subframe without sacrificing extra time to GP symbols. This may be accomplished by using fractional symbol lengths for the GP symbols, for instance. The durations of the fractional symbols may differ in length but may have a sum equal to a symbol period. This scheme can also be advantageous if different cyclic prefixes (CPs) are used for DL and UL. For instance cases, the sum of two guard periods 340 within a subframe 310 may be equal to the length of a low latency symbol 330 within the subframe 310—e.g., two guard periods 340 may provide a UE 115 switching time while using the length of a single low latency symbol 330 or a fraction of a single low latency symbol 330 especially when low latency UL has a different CP than low latency DL. Accordingly, more low latency symbols 330 may be available for communication.

The distribution of the low latency downlink symbols 335 and the low latency uplink symbols 345 may be determined by a base station 105 and may be different for different subframes 310. Additionally, the configuration of a downlink subframe 315 may be different from the configuration of an uplink subframe 325. Some subframes 310 and low latency symbols 330 may not be suitable for flexible scheduling. For example, a subframe 310 may be allocated to carry control information or system information blocks (SIBs), which may be used by a UE for system acquisition. As an example, SIB 1 may be scheduled in subframes having SFN=5, 25, 45, 65, etc., and consequently, these subframes may not be suitable for flexible scheduling. Additionally, some symbols may be used by a UE 115 for channel estimation, synchronization (e.g., primary synchronization signal PSS or secondary synchronization signal (SSS)), system information broadcast (e.g., primary broadcast channel or PBCH), time/frequency tracking, radio resource management, radio link monitoring, interference estimation, etc. (e.g., cell-specific reference signals (CRS)). In such cases, the base station 105 may refrain from scheduling the unsuitable TTIs (e.g., subframes 310 or low latency symbols 330) according to low latency procedures. In a similar fashion, a base station 105 may refrain from scheduling resources according to the low latency configuration described herein at a resource block-level or resource element-level. As an example, the center 6 resource blocks in certain subframes may be used to carry PSS, SSS, and/or PBCH, and hence may not be suitable for flexible scheduling.

A base station 105 may use control signaling to support different TTI configurations. For instance, a base station 105 may signal to a UE 115 which low latency symbols 330 are for downlink and which low latency symbols 330 are for uplink via explicit indication (e.g., via a control channel such as physical downlink control channel (PDCCH)). In some examples, a base station 105 may utilize a low latency control channel (e.g., uPDCCH) for such scheduling. In another example, a UE 115 may use implicit determination (e.g., based on the scheduling decision by the base station 105) to determine the data direction of each low latency symbol 330.

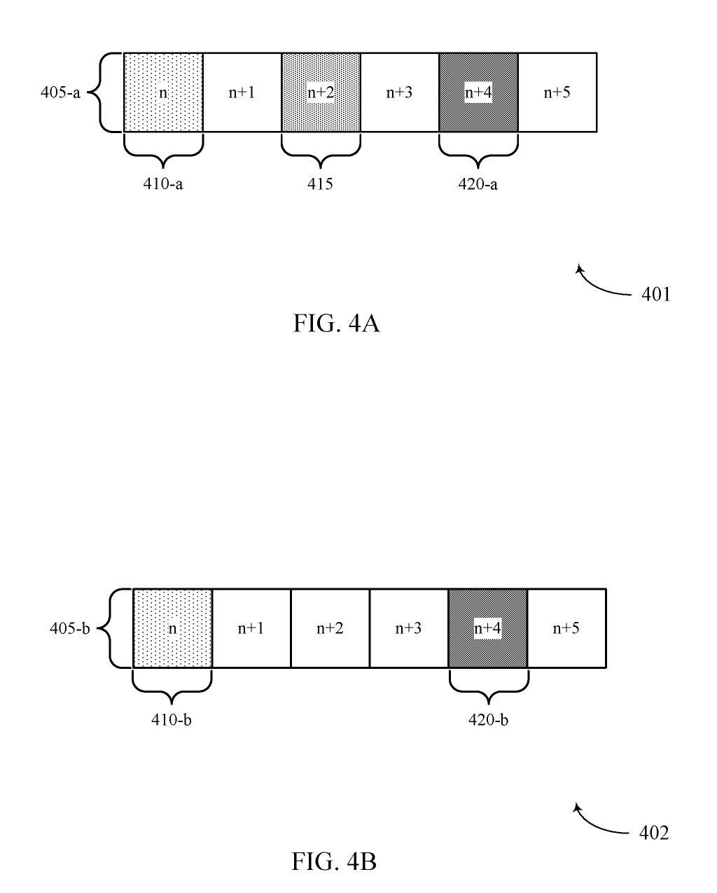

FIGS. 4A and 4B illustrate example TTI configuration 401 and 402 that supports low latency under TDD and flexible FDD in accordance with various aspects of the present disclosure. TTI configurations 401 and 402 may illustrate aspects of the low latency symbols 330 described with reference to FIG. 3, and may be utilized by UEs 115 and base stations 105 described with reference to FIGS. 1 and 2. In the example of FIG. 4A, in TTI n 410-a, a UE 115 may temporarily determine that TTI n+4 420-a is an UL TTI. But if in a subsequent TTI n+2 415, an explicit signaling indicates otherwise, UE 115 may recognize TTI n+4 420-a as a low latency DL symbol.

In the example of FIG. 4B, in TTI n 410-b, a UE 115 may determine that TTI n+4 420-b is an UL symbol or not, based on DL/UL grants or an explicit indication received during TTI n 410-b, where the explicit indication, if present, takes precedence. In other words, a UE 115 may determine a communication direction of either of both TTI n 410 and TTI n+4 420 with explicit signaling or blind decoding, or both.

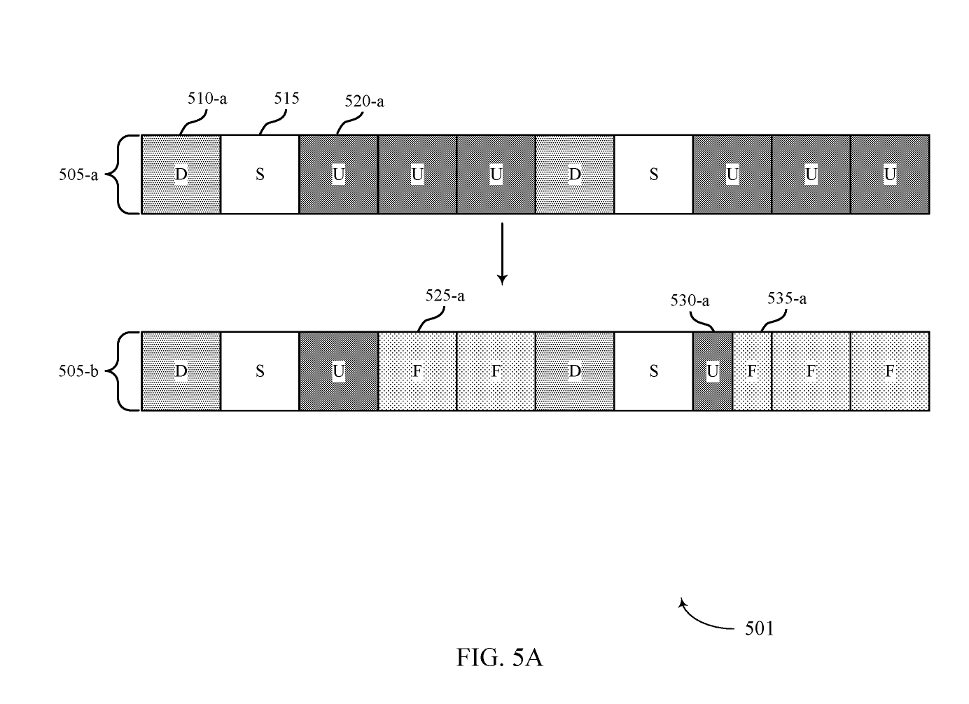

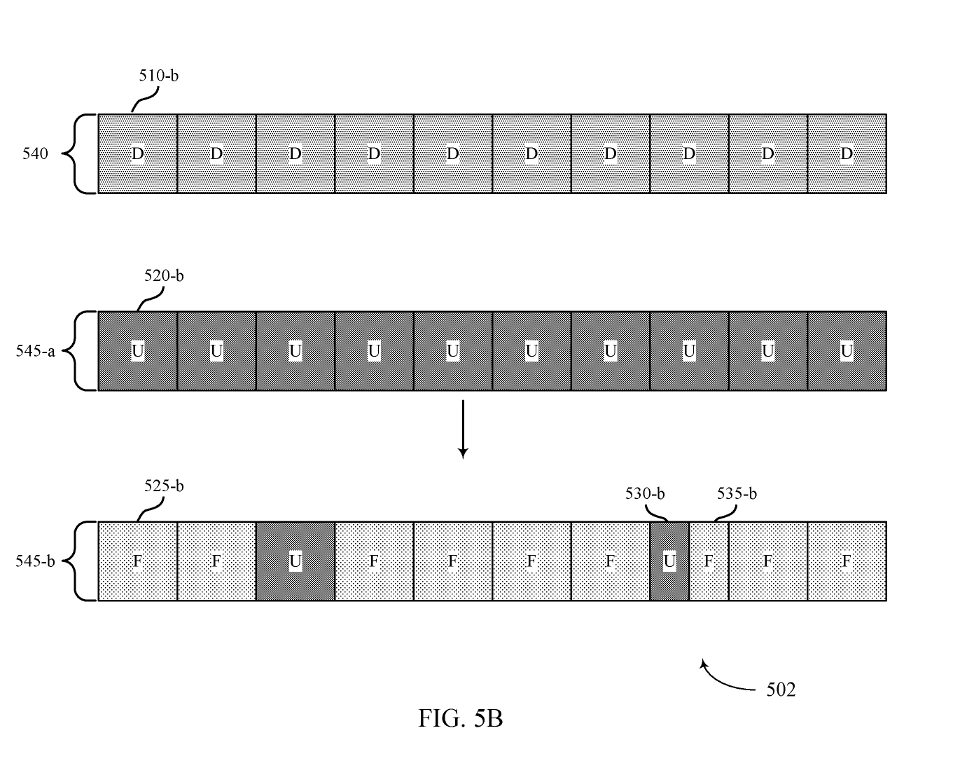

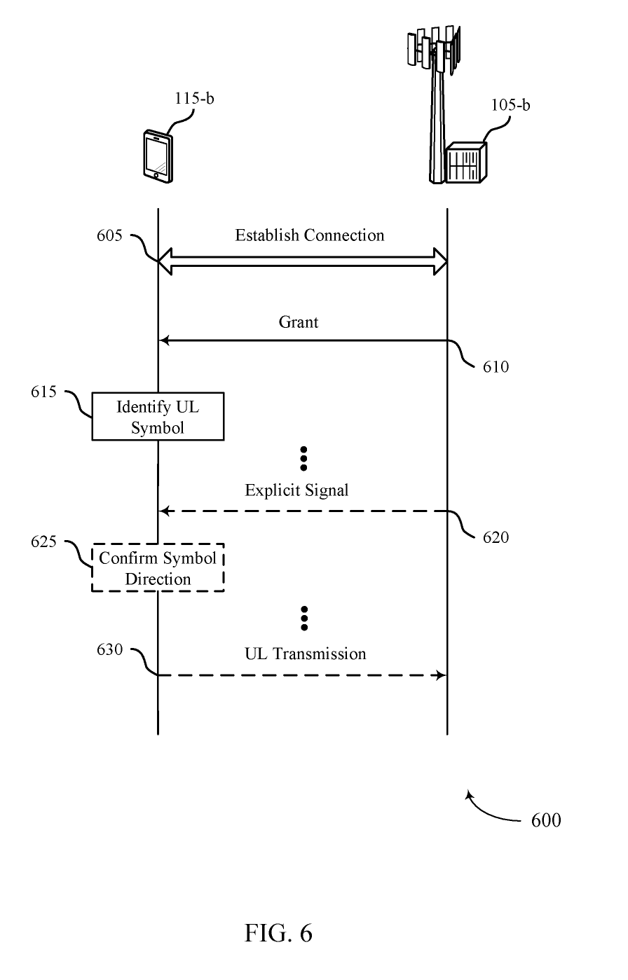

FIGS. 5A and 5B illustrate examples of frame configurations 501 and 502 that support low latency under TDD and flexible FDD. Frame configurations may be utilized by UEs 115 and base stations 105 described with reference to FIGS. 1 and 2. Frame configurations 501 and 502 may illustrate aspects of frames, subframes, and TTIs described with reference to FIGS. 3, 4A, and 4B. In some cases, frame configuration 502 may be referred to as a flexible FDD configuration or structure.

For instance, in the example of FIG. 5A, a UE 115 may receive system information (e.g., SIB 1), which may indicate DL/UL configuration 505-a. Configuration 505-a may include downlink (DL) subframe 510-a, an uplink (UL) subframe 520-a, and a special subframe 515. The UE 115 may determine, however, that configuration 505-b may be used to flexibly and dynamically schedule low latency operation. Thus, some or all of a subframe configured for legacy UL operation may be dynamically scheduled for low latency communications. For instance, UL subframes 520-a may be scheduled as flexible subframes 525-a, which may be available for UL or DL communications, and which may have portions configurable for low latency communications. In some examples, HARQ timing or UL scheduling timing, or both, may be modified such that corresponding UL control information or UL data transmissions are concentrated into a smaller set of UL subframes 520-a (or a single UL subframe 520-a). In such cases, subframes otherwise configured as UL subframes 520-a may be scheduled as flexible subframes 525-a. Certain UL subframes 520-a may be scheduled with an UL portion 530-a and flexible portion 535-a, which may include one or more symbol periods.

Likewise, as depicted in the example of FIG. 5B, a UE 115 may receive system information (e.g., SIB 1), which may indicate DL/UL configuration 540 and 545-a, respectively, for an FDD frame. Configuration 540 and 545-a may include downlink subframes 510-b and uplink subframes 520-b on paired spectrum resources.

The UE 115 may determine, however, that configuration 545-b may be used to flexibly and dynamically schedule low latency operation. Thus, some or all of a subframe configured for legacy UL operation may be dynamically scheduled for low latency communications. For instance, UL subframes 520-b may be scheduled as flexible subframes 525-b, which may be available for UL or DL communications, and which may have portions configurable for low latency communications. Certain UL subframes 520-b may be scheduled with an UL portion 530-b and flexible portion 535-b, which may include one or more symbol periods. According to the examples of FIGS. 5A and 5B, a UE may thus determine a duplexing configuration of a frame, the UE 115 may determine that some portions of the frame are configurable for low latency operation, and the UE 115 may communicate accordingly.

FIG. 6 illustrates an example of a process flow 600 in a system that supports low latency under TDD and flexible FDD in accordance with various aspects of the present disclosure. Process flow 600 may include steps performed by UE 115-b and base station 105-b, which may be examples of a UE 115 and base station 105 described with reference to FIGS. 1 and 2.

At step 605, UE 115-b and base station 105-b may operate in a system that supports communication using two or more TTI durations, and establish a wireless connection that supports reduced TTI durations for low latency operation. In the example of FIG. 6, a first duration of TTI may be on the order of 1 ms, while a second duration of TTI may be less than 1 ms (e.g., a symbol period).

At step 610, UE 115-b may receive a grant from base station 105-b (either and UL grant or a DL grant). That is, UE 115-b may monitor for a grant during a first TTI of the second duration. UE 115-b may receive the grant during the first TTI based on monitoring for the grant, such that the communication direction of the second TTI may be determined based on the received grant and a HARQ timing or UL scheduling timing.

In some cases, UE 115-b may determine that no grant may be received during the first TTI based on monitoring for the grant. In some examples, the communication direction of the second TTI is determined based on the received indicator.

At step 615, based on the grant, UE 115-b may identify a subsequent TTI (e.g., a symbol period) that may be an UL TTI.

At step 620, in some cases base station 105-b may transmit explicit signaling to UE 115-b indicative of a communication direction of a TTI. That is, UE 115-b may monitor for an indicator of a communication direction of a second TTI of the second duration. UE 115-b may receive the indicator during the first TTI or a subsequent TTI based on monitoring for the indicator, and may re-determine the communication direction of the second TTI based on the received indicator. UE 115-b may receive the indicator during the first TTI or a subsequent TTI of the second duration. In some examples, the indicator may be a physical control channel. The indicator may, additionally or alternatively, designate a communication direction for a set of TTIs that includes the second TTI. In some cases, UE 115-b may adapt the HARQ timing or the UL scheduling timing, or both, based on receiving the indicator.

In some cases, UE 115-b may receive the indicator in the first TTI based on monitoring for the indicator, such that the set of TTIs includes a third TTI of the second duration after the second TTI. Base station 105-b may determine a traffic condition of a system including UE 115-b and a second UE 115. The traffic condition may be used to schedule the UL and DL TTIs. That is, base station 105-b may transmit the indicator based on traffic associated with the first UE or the second UE. In some examples the indicator is transmitted during the first TTI or a subsequent TTI.

At step 625, UE 115-b may confirm that the subsequent TTI is an UL TTI (or determine that it is a DL TTI) based on the explicit signal. UE 115-b may determine the communication direction of the second TTI based on whether the indicator may be received and whether a grant may be received during the first TTI. In some examples the communication direction of the second TTI is determined based on a carrier type, a subframe type or reference signal time-domain pattern. In some examples the carrier type may include of at least a carrier operated in a licensed spectrum, or a carrier operated in a contention based spectrum, and the subframe type consists of at least of a multicast broadcast single frequency network (MBSFN) subframe, a special subframe, or a regular downlink subframe.

In some cases, UE 115-b may determine that a duration includes a guard period, such that the guard period determination may be based on the grant, HARQ timing, UL scheduling timing, or the indicator, or the like.

In some examples, UE 115-b may identify a communication direction of a third TTI, the third TTI having the first duration, and where the second TTI is within the third TTI. UE 115-b may determine that the communication direction of the second TTI is reverse from the communication direction of the third TTI. In some cases, UE 115-b may identify a duration within the first TTI, where the duration comprises a guard period. In some examples, the resources of the second TTI are frequency division multiplexing (FDM) with resources of the first TTI.

At step 630, UE 115-b may transmit during the subsequent TTI (in the case where it received an UL grant). That is, base station 105-b may communicate with UE 115-b based on the grant and the indicator. For example, UE 115-b may communicate with base station 105-b in the communication direction of the second TTI during the second TTI. In some cases, UE 115-b may communicate an indication of the presence of the second TTI within the third TTI, where the communication during the second TTI is based on the indication. In other examples, UE 115-b may monitor the subsequent TTI for DL data (if it is a DL TTI) or refrain from monitoring if it is an UL TTI (in which it is not scheduled to transmit). That is, UE 115-b may refrain from monitoring a TTI of the second TTI duration based on the received indicator and the determined communication direction of the second TTI.

In some cases, UE 115-b may determine a duplexing configuration of a frame including TTIs of the first duration. Thus, UE 115-b may determine that at least a portion of an UL TTI of the frame may be configurable as one or more TTIs of the second duration. UE 115-b may then receive a first DL transmission during a TTI of the second duration that includes the portion of the UL TTI. UE 115-b may also receive a second DL transmission during a DL TTI of the frame. In some examples the first and second DL transmissions are scheduled by a common grant. In some examples the duplexing configuration includes a TDD configuration. In some examples the duplexing configuration is a FDD configuration.

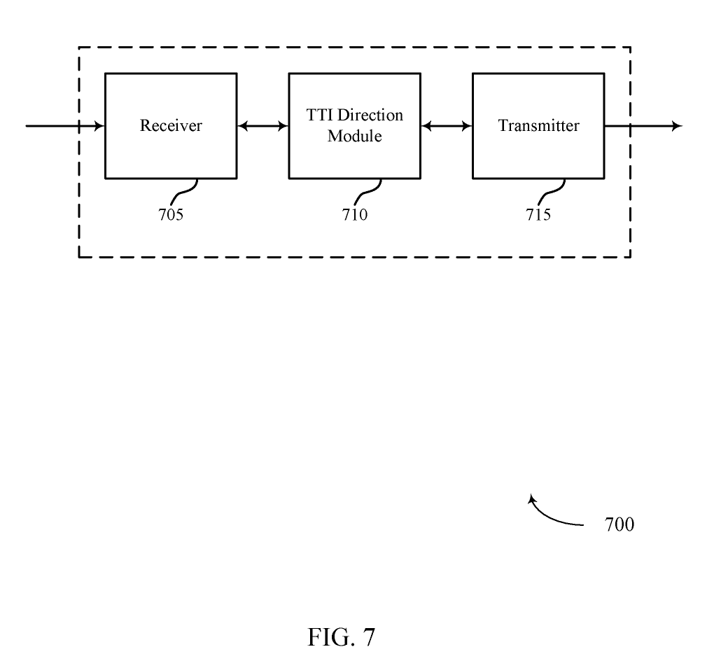

FIG. 7 shows a block diagram of a wireless device 700 configured that supports low latency under TDD and flexible FDD in accordance with various aspects of the present disclosure. Wireless device 700 may be an example of aspects of a UE 115 described with reference to FIGS. 1-6. Wireless device 700 may include a receiver 705, a TTI direction module 710, or a transmitter 715. Wireless device 700 may also include a processor. Each of these components may be in communication with one another.

The receiver 705 may receive information such as packets, user data, or control information associated with various information channels (e.g., control channels, data channels, and information related to low latency under TDD and flexible FDD, etc.). Information may be passed on to the TTI direction module 710, and to other components of wireless device 700. In some examples, the receiver 705 may receive a first DL transmission during a TTI of the second duration that includes the portion of the UL TTI. In some examples, the receiver 705 may receive a second DL transmission during a DL TTI of the frame. In some examples, the first and second DL transmissions are scheduled by a common grant.

The TTI direction module 710 may monitor for a grant during a first TTI of the second duration, monitor for an indicator of a communication direction of a second TTI of the second duration, and determine the communication direction of the second TTI based on whether the indicator is received and whether the grant is received during the first TTI.

The transmitter 715 may transmit signals received from other components of wireless device 700. In some examples, the transmitter 715 may be collocated with the receiver 705 in a transceiver module. The transmitter 715 may include a single antenna, or it may include a plurality of antennas.

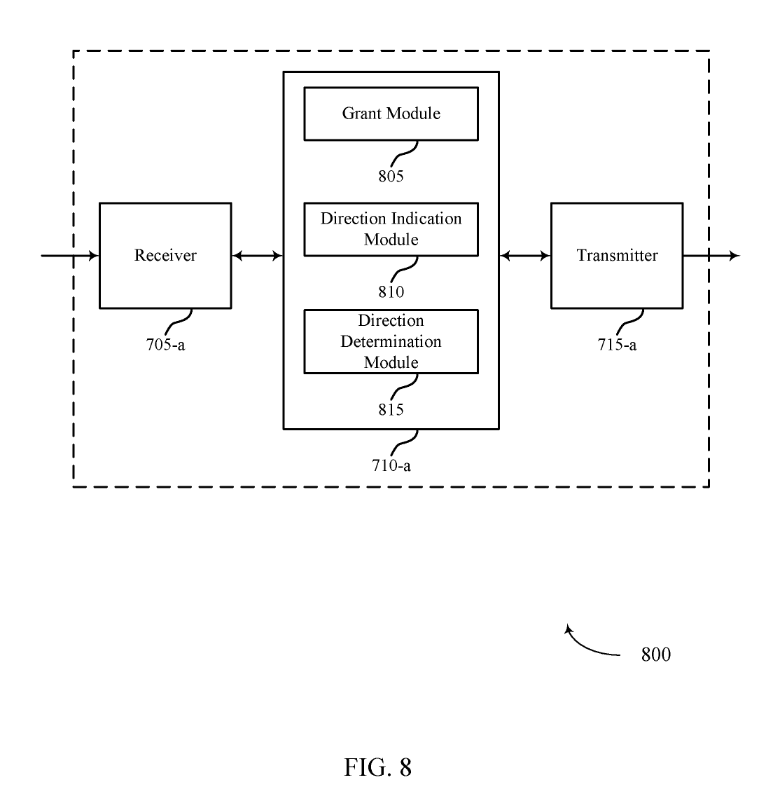

FIG. 8 shows a block diagram of a wireless device 800 that supports low latency under TDD and flexible FDD in accordance with various aspects of the present disclosure. Wireless device 800 may be an example of aspects of a wireless device 700 or a UE 115 described with reference to FIGS. 1-7. Wireless device 800 may include a receiver 705-a, a TTI direction module 710-a, or a transmitter 715-a. Wireless device 800 may also include a processor. Each of these components may be in communication with one another. The TTI direction module 710-a may also include a grant module 805, a direction indication module 810, and a direction determination module 815.

The receiver 705-a may receive information which may be passed on to TTI direction module 710-a, and to other components of wireless device 800. The TTI direction module 710-a may perform the operations described with reference to FIG. 7. The transmitter 715-a may transmit signals received from other components of wireless device 800.

The grant module 805 may monitor for a grant during a first TTI of the second duration as described with reference to FIGS. 2-6. The grant module 805 may also receive the grant during the first TTI based on monitoring for the grant, and the communication direction of the second TTI may be determined based on the received grant and a HARQ timing or UL scheduling timing. The grant module 805 may also determine that no grant is received during the first TTI based on monitoring for the grant.

The direction indication module 810 may monitor for an indicator of a communication direction of a second TTI of the second duration as described with reference to FIGS. 2-6. The direction indication module 810 may also receive the indicator during the first TTI or a subsequent TTI of the second duration based on monitoring for the indicator. In some examples, the indicator is a physical control channel. In some examples, the indicator designates a communication direction for a set of TTIs that includes the second TTI. The direction indication module 810 may also receive the indicator in the first TTI based on monitoring for the indicator, such that the set of TTIs includes a third TTI of the second duration after the second TTI. The direction indication module 810 may also transmit the indicator based on traffic associated with the first UE or the second UE. In some examples, the indicator may be transmitted during the first TTI or a subsequent TTI.

The direction determination module 815 may determine the communication direction of the second TTI based on whether the indicator is received and whether the grant is received during the first TTI as described with reference to FIGS. 2-6. The direction determination module 815 may also receive the indicator during the first TTI or a subsequent TTI based on monitoring for the indicator, and re-determining the communication direction of the second TTI based on the received indicator. In some examples, the communication direction of the second TTI may be determined on the received indicator. In some examples, the communication direction of the second TTI may be determined based on a carrier type, a subframe type or reference signal time-domain pattern. In some examples, the carrier type includes a carrier operated in a licensed spectrum or a carrier operated in a contention-based spectrum (such as unlicensed or shared spectrum), and the subframe type consists of at least of a multicast broadcast single frequency network (MB SFN) subframe, a special subframe, or a regular downlink subframe.

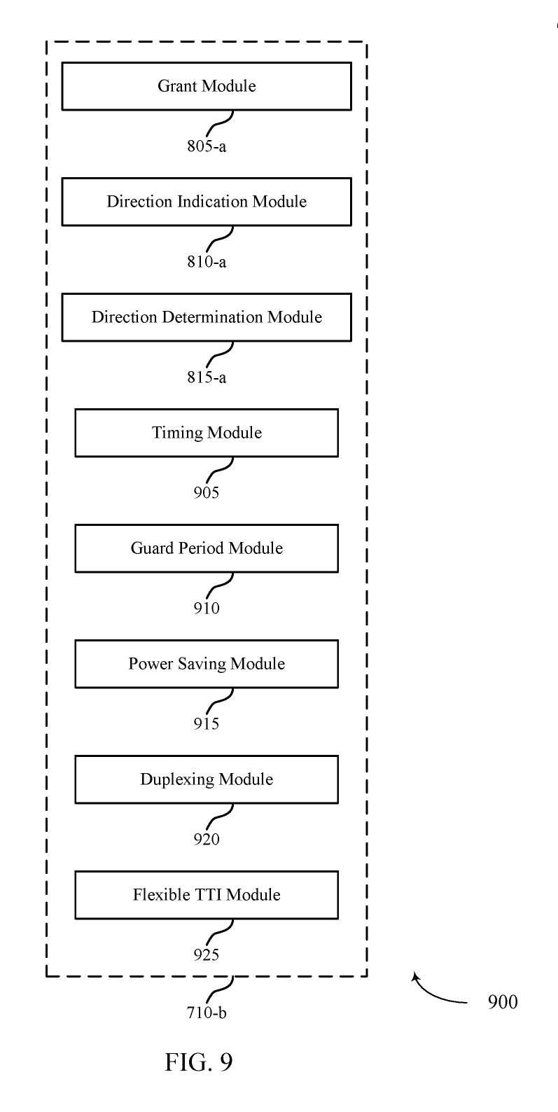

FIG. 9 shows a block diagram 900 of a TTI direction module 710-b which may be a component of a wireless device 700 or a wireless device 800 that supports low latency under TDD and flexible FDD in accordance with various aspects of the present disclosure. The TTI direction module 710-b may be an example of aspects of a TTI direction module 710 described with reference to FIGS. 7-8. The TTI direction module 710-b may include a grant module 805-a, a direction indication module 810-a, and a direction determination module 815-a. Each of these modules may perform the functions described with reference to FIG. 8. The TTI direction module 710-b may also include a timing module 905, a guard period module 910, a power saving module 915, a duplexing module 920, and a flexible TTI module 925.

The timing module 905 may adapt the HARQ timing or the UL scheduling timing, or both, based on receiving the indicator as described with reference to FIGS. 2-6. The guard period module 910 may determine that a duration includes a guard period, and the guard period determination may be based on the grant, HARQ timing, UL scheduling timing, or the indicator, or any combination thereof as described with reference to FIGS. 2-6. The power saving module 915 may refrain from monitoring at least one TTI of the second TTI duration based on the received indicator and the determined communication direction of the second TTI as described with reference to FIGS. 2-6.

The duplexing module 920 may determine a duplexing configuration of a frame includes TTIs of the first duration as described with reference to FIGS. 2-6. In some examples, the duplexing configuration may be a TDD configuration. In some examples, the duplexing configuration may be a FDD configuration. The flexible TTI module 925 may determine that at least a portion of an UL TTI of the frame is configurable as one or more TTIs of the second duration as described with reference to FIGS. 2-6.

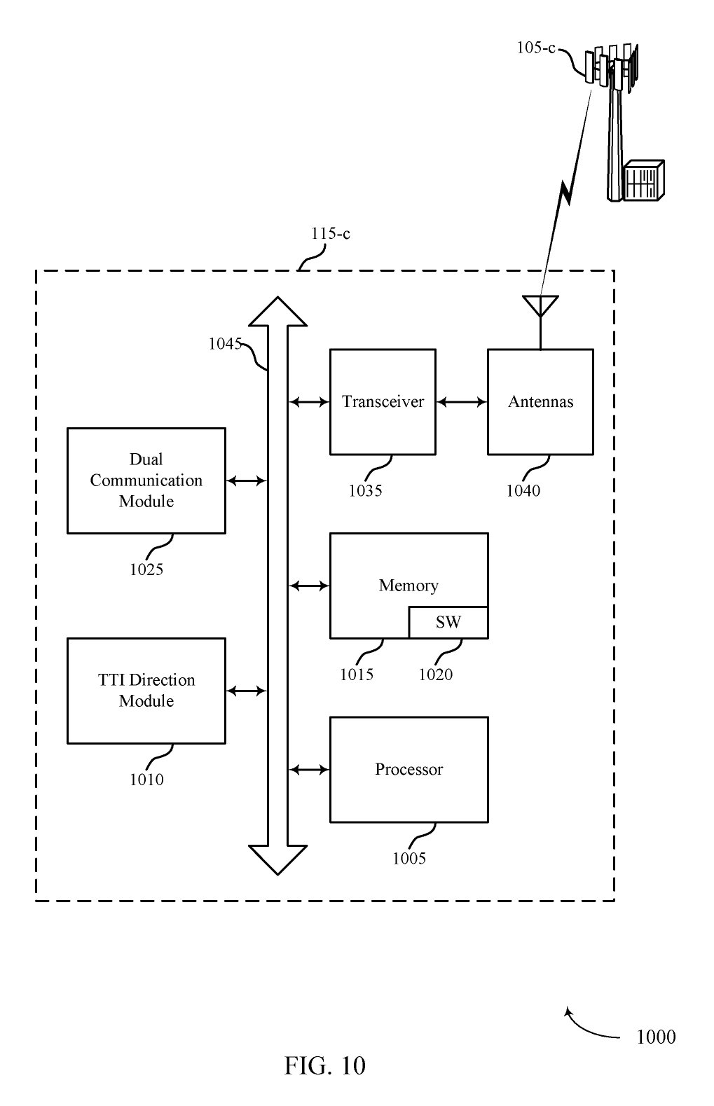

FIG. 10 shows a diagram of a system 1000, including a UE 115, which supports low latency under TDD and flexible FDD in accordance with various aspects of the present disclosure. System 1000 may include UE 115-c, which may be an example of a wireless device 700, a wireless device 800, or a UE 115 described with reference to FIGS. 1, 2 and 7-9. UE 115-c may include a TTI direction module 1010, which may be an example of a TTI direction module 710 described with reference to FIGS. 7-9. UE 115-c may also include a dual communication module 1025. UE 115-c may also include components for bi-directional voice and data communications including components for transmitting communications and components for receiving communications. For example, UE 115-c may communicate bi-directionally with base station 105-c or another UE 115.

The dual communication module 1025 may identify a communication direction of a third TTI, the third TTI having the first duration, where the second TTI is within the third TTI as described with reference to FIGS. 2-6. It may also determine that the communication direction of the second TTI is reverse from the communication direction of the third TTI. The dual communication module 1025 may also communicate in the communication direction of the second TTI during the second TTI. It may also communicate an indication of the presence of second TTI within the third TTI, such that the communication during the second TTI may be based on the indication. The dual communication module 1025 may also be configured such that resources of the second TTI are FDM with resources of the third TTI.

UE 115-c may also include a processor 1005, and memory 1015 (including software (SW) 1020), a transceiver 1035, and one or more antenna(s) 1040, each of which may communicate, directly or indirectly, with one another (e.g., via buses 1045). The transceiver 1035 may communicate bi-directionally, via the antenna(s) 1040 or wired or wireless links, with one or more networks, as described above. For example, the transceiver 1035 may communicate bi-directionally with a base station 105 or another UE 115. The transceiver 1035 may include a modem to modulate the packets and provide the modulated packets to the antenna(s) 1040 for transmission, and to demodulate packets received from the antenna(s) 1040. While UE 115-c may include a single antenna 1040, UE 115-c may also have multiple antennas 1040 capable of concurrently transmitting or receiving multiple wireless transmissions.

The memory 1015 may include random access memory (RAM) and read only memory (ROM). The memory 1015 may store computer-readable, computer-executable software/firmware code 1020 including instructions that, when executed, cause the processor 1005 to perform various functions described herein (e.g., low latency under TDD and flexible FDD, etc.). Alternatively, the software/firmware code 1020 may not be directly executable by the processor 1005 but cause a computer (e.g., when compiled and executed) to perform functions described herein. The processor 1005 may include an intelligent hardware device, (e.g., a central processing unit (CPU), a microcontroller, an application specific integrated circuit (ASIC), etc.)

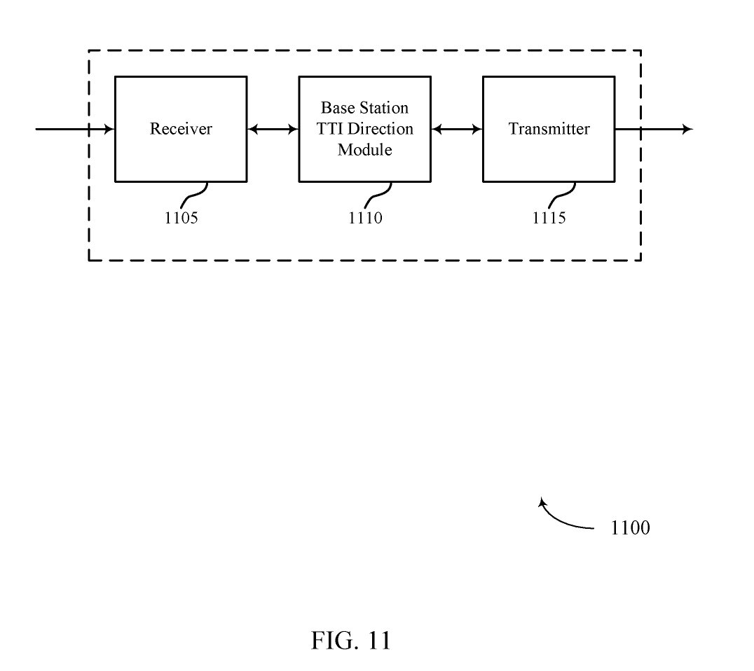

FIG. 11 shows a block diagram of a wireless device 1100 that supports low latency under TDD and flexible FDD in accordance with various aspects of the present disclosure. Wireless device 1100 may be an example of aspects of a base station 105 described with reference to FIGS. 1-10. Wireless device 1100 may include a receiver 1105, a base station TTI direction module 1110, or a transmitter 1115. Wireless device 1100 may also include a processor. Each of these components may be in communication with one another.

The receiver 1105 may receive information such as packets, user data, or control information associated with various information channels (e.g., control channels, data channels, and information related to low latency under TDD and flexible FDD, etc.). Information may be passed on to the base station TTI direction module 1110, and to other components of wireless device 1100. In some examples, the receiver 1105 may communicate with the first UE based on the grant and the indicator.

The base station TTI direction module 1110 may transmit a grant to a first UE in a first TTI of the second duration, transmit to the first UE an indicator of a communication direction of a second TTI of the second duration, and communicate with the first UE based on the grant and the indicator.

The transmitter 1115 may transmit signals received from other components of wireless device 1100. In some examples, the transmitter 1115 may be collocated with the receiver 1105 in a transceiver module. The transmitter 1115 may include a single antenna, or it may include a plurality of antennas.

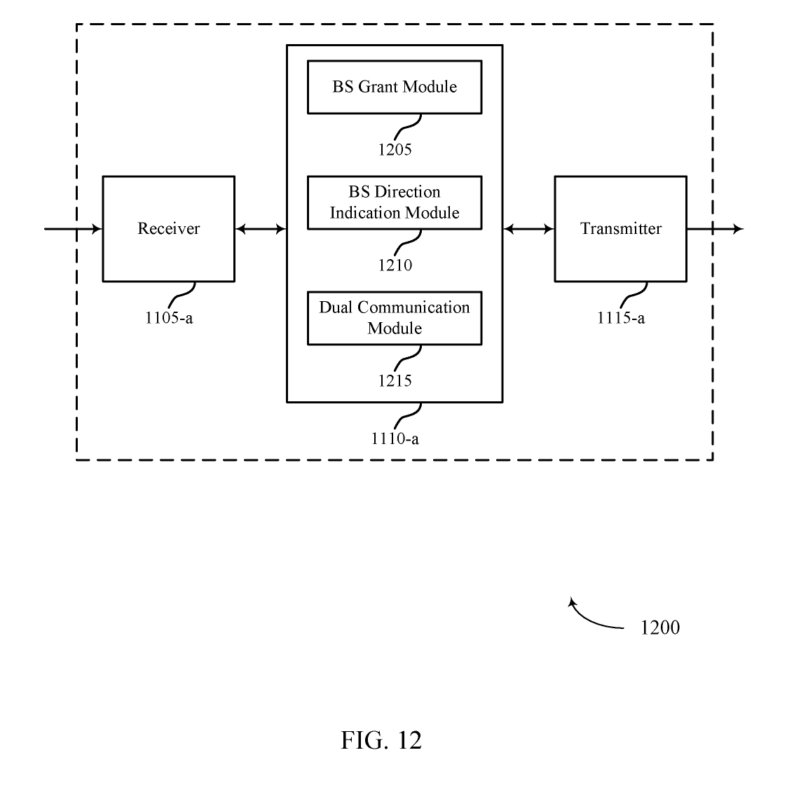

FIG. 12 shows a block diagram of a wireless device 1200 that supports low latency under TDD and flexible FDD in accordance with various aspects of the present disclosure. Wireless device 1200 may be an example of aspects of a wireless device 1100 or a base station 105 described with reference to FIGS. 1-11. Wireless device 1200 may include a receiver 1105-a, a base station TTI direction module 1110-a, or a transmitter 1115-a. Wireless device 1200 may also include a processor. Each of these components may be in communication with one another. The base station TTI direction module 1110-a may also include a BS grant module 1205, a BS direction indication module 1210, and a dual communication module 1215.

The receiver 1105-a may receive information which may be passed on to base station TTI direction module 1110-a, and to other components of wireless device 1200. The base station TTI direction module 1110-a may perform the operations described with reference to FIG. 11. The transmitter 1115-a may transmit signals received from other components of wireless device 1200.

The BS grant module 1205 may transmit a grant to a first UE in a first TTI of the second duration as described with reference to FIGS. 2-6. The BS direction indication module 1210 may transmit to the first UE an indicator of a communication direction of a second TTI of the second duration as described with reference to FIGS. 2-6.

The dual communication module 1215 may identify a third TTI, the third TTI having the first duration, where the second TTI is within the third TTI as described with reference to FIGS. 2-6. The dual communication module 1215 may also determine that communication direction of the second TTI is reverse from the communication direction of the third TTI. The dual communication module 1215 may also communicate in the communication direction of the second TTI during the second TTI. The dual communication module 1215 may also communicate an indication of the presence of second TTI within the third TTI, such that the communication during the second TTI may be based on the indication. The dual communication module 1215 may also be configured such that resources of the second TTI are FDM with resources of the third TTI.

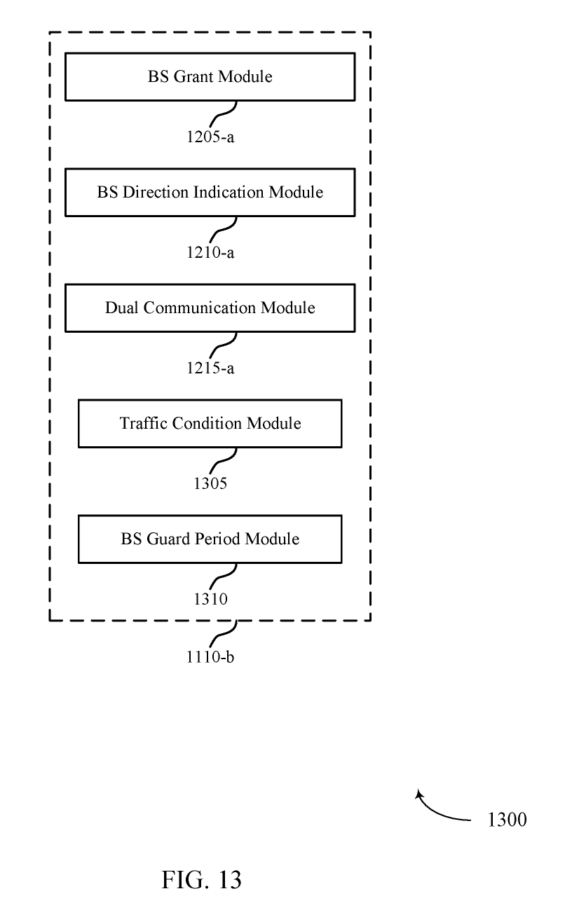

FIG. 13 shows a block diagram 1300 of a base station TTI direction module 1110-b which may be a component of a wireless device 1100 or a wireless device 1200 that supports low latency under TDD and flexible FDD in accordance with various aspects of the present disclosure. The base station TTI direction module 1110-b may be an example of aspects of a base station TTI direction module 1110 described with reference to FIGS. 11-12. The base station TTI direction module 1110-b may include a BS grant module 1205-a, a BS direction indication module 1210-a, and a dual communication module 1215-a. Each of these modules may perform the functions described with reference to FIG. 12. The base station TTI direction module 1110-b may also include a traffic condition module 1305, and a BS guard period module 1310.

The traffic condition module 1305 may determine a traffic condition of a system that includes the first UE and a second UE as described with reference to FIGS. 2-6. The BS guard period module 1310 may identify a duration within the third TTI, and the duration may be a guard period as described with reference to FIGS. 2-6.

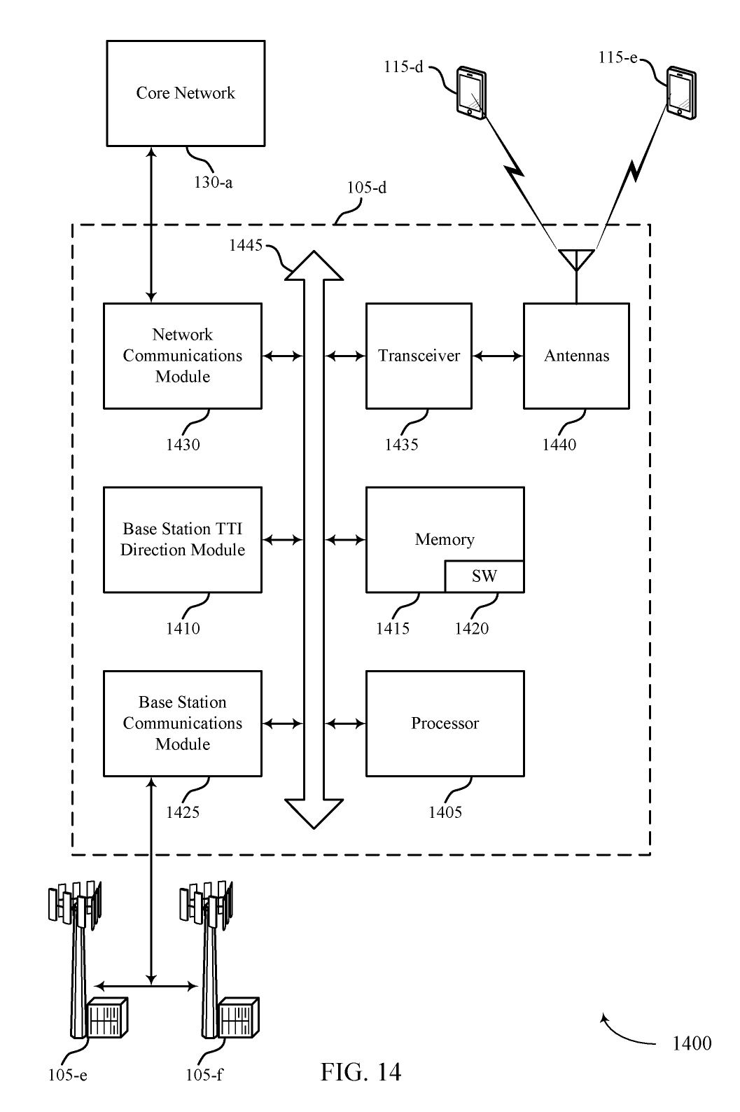

FIG. 14 shows a diagram of a system 1400, including a base station 105, which supports low latency under TDD and flexible FDD in accordance with various aspects of the present disclosure. System 1400 may include base station 105-d, which may be an example of a wireless device 1100, a wireless device 1200, or a base station 105 described with reference to FIGS. 1, 2 and 11-13. Base Station 105-d may include a base station TTI direction module 1410, which may be an example of a base station TTI direction module 1110 described with reference to FIGS. 11-13. Base Station 105-d may also include components for bi-directional voice and data communications including components for transmitting communications and components for receiving communications. For example, base station 105-d may communicate bi-directionally with UE 115-d or UE 115-e.

In some cases, base station 105-d may have one or more wired backhaul links. Base station 105-d may have a wired backhaul link (e.g., S1 interface, etc.) to the core network 130. Base station 105-d may also communicate with other base stations 105, such as base station 105-e and base station 105-f via inter-base station backhaul links (e.g., an X2 interface). Each of the base stations 105 may communicate with UEs 115 using the same or different wireless communications technologies. In some cases, base station 105-d may communicate with other base stations such as 105-e or 105-f utilizing base station communications module 1425. In some examples, base station communications module 1425 may provide an X2 interface within an LTE/LTE-A wireless communication network technology to provide communication between some of the base stations 105. In some examples, base station 105-d may communicate with other base stations through core network 130. In some cases, base station 105-d may communicate with the core network 130 through network communications module 1430.

Base station 105-d may include a processor 1405, memory 1415 (including software (SW) 1420), transceiver 1435, and antenna(s) 1440, which each may be in communication, directly or indirectly, with one another (e.g., over bus system 1445). The transceivers 1435 may be configured to communicate bi-directionally, via the antenna(s) 1440, with the UEs 115, which may be multi-mode devices. The transceiver 1435 (or other components of the base station 105-d) may also be configured to communicate bi-directionally, via the antennas 1440, with one or more other base stations (not shown). The transceiver 1435 may include a modem configured to modulate the packets and provide the modulated packets to the antennas 1440 for transmission, and to demodulate packets received from the antennas 1440. The base station 105-d may include multiple transceivers 1435, each with one or more associated antennas 1440. The transceiver may be an example of a combined receiver 1105 and transmitter 1115 of FIG. 11.

The memory 1415 may include RAM and ROM. The memory 1415 may also store computer-readable, computer-executable software code 1420 containing instructions that are configured to, when executed, cause the processor 1405 to perform various functions described herein (e.g., low latency under TDD and flexible FDD, selecting coverage enhancement techniques, call processing, database management, message routing, etc.). Alternatively, the software 1420 may not be directly executable by the processor 1405 but be configured to cause the computer, e.g., when compiled and executed, to perform functions described herein. The processor 1405 may include an intelligent hardware device, e.g., a CPU, a microcontroller, an ASIC, etc. The processor 1405 may include various special purpose processors such as encoders, queue processing modules, base band processors, radio head controllers, digital signal processor (DSPs), and the like.

The base station communications module 1425 may manage communications with other base stations 105. In some cases, a communications management module may include a controller or scheduler for controlling communications with UEs 115 in cooperation with other base stations 105. For example, the base station communications module 1425 may coordinate scheduling for transmissions to UEs 115 for various interference mitigation techniques such as beamforming or joint transmission.

The components of wireless device 700, wireless device 800, and TTI direction module 710, wireless device 1100, wireless device 1200, base station TTI direction module 1110, and system 1400 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

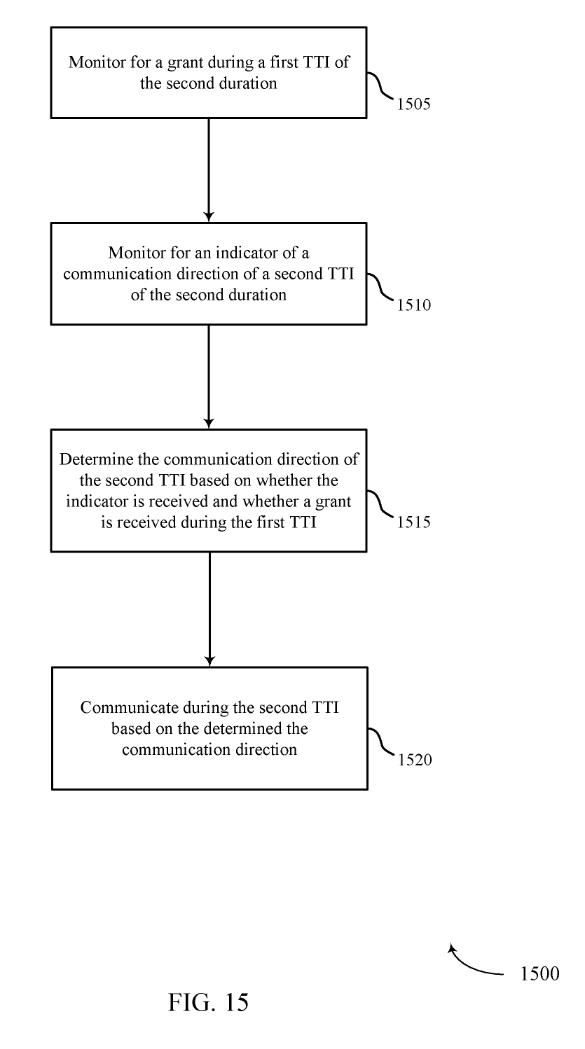

FIG. 15 shows a flowchart illustrating a method 1500 for low latency under TDD and flexible FDD in accordance with various aspects of the present disclosure. The operations of method 1500 may be implemented by a UE 115 or its components as described with reference to FIGS. 1-14. For example, the operations of method 1500 may be performed by the TTI direction module 710 as described with reference to FIGS. 7-10. In some examples, a UE 115 may execute a set of codes to control the functional elements of the UE 115 to perform the functions described below. Additionally or alternatively, the UE 115 may perform aspects the functions described below using special-purpose hardware.

At block 1505, the UE 115 may monitor for a grant during a first TTI of the second duration as described with reference to FIGS. 2-6. In certain examples, the operations of block 1505 may be performed by the grant module 805 as described with reference to FIG. 8.

At block 1510, the UE 115 may monitor for an indicator of a communication direction of a second TTI of the second duration as described with reference to FIGS. 2-6. In some examples, the indicator may comprise a physical control channel. In certain examples, the operations of block 1510 may be performed by the direction indication module 810 as described with reference to FIG. 8.

At block 1515, the UE 115 may determine the communication direction of the second TTI based at least in part on whether the indicator is received and whether the grant is received during the first TTI as described with reference to FIGS. 2-6. In certain examples, the operations of block 1515 may be performed by the direction determination module 815 as described with reference to FIG. 8.

In some cases of the method, the indicator may designate a communication direction for a set of TTIs comprising the second TTI, and the UE 115 may receive the indicator in the first TTI based on monitoring for the indicator, where the set of TTIs comprises a third TTI of the second duration after the second TTI. In some examples, the communication direction of the second TTI may be determined based on a carrier type, a subframe type, or reference signal time-domain pattern. The carrier type may include at least one of a carrier operated in a licensed spectrum or a carrier operated in a contention-based spectrum, and the subframe type may be a multicast broadcast single frequency network (MB SFN) subframe, a special subframe, or a downlink subframe.

At block 1520, the UE 115 may communicate during the second TTI based on the determined the communication direction as described with reference to FIGS. 2-6. In certain examples, the operations of block 1520 may be performed by receiver 705-a and/or transmitter 715-a as described with reference to FIG. 8.

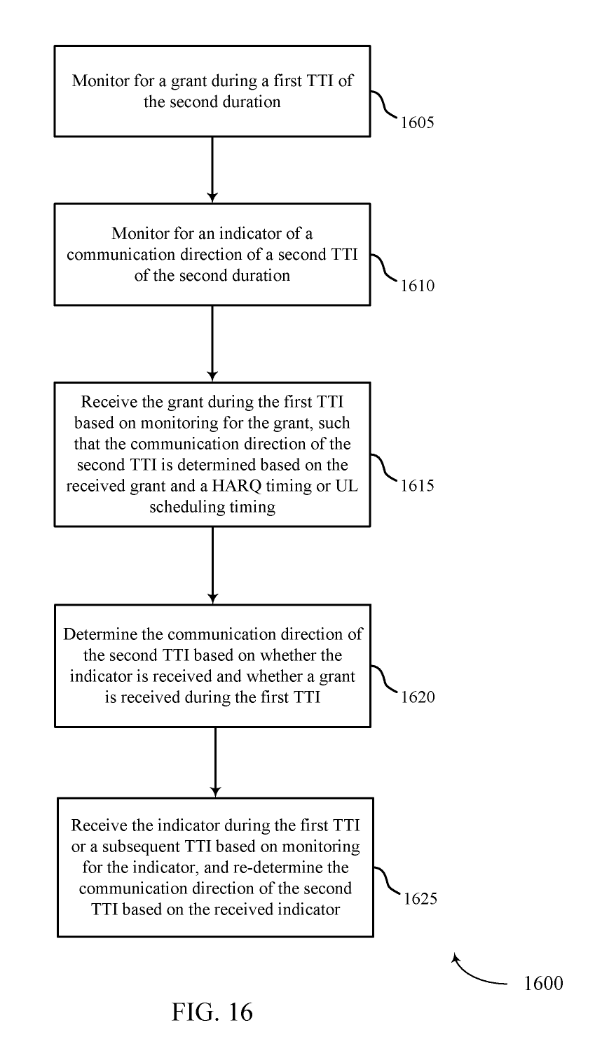

FIG. 16 shows a flowchart illustrating a method 1600 for low latency under TDD and flexible FDD in accordance with various aspects of the present disclosure. The operations of method 1600 may be implemented by a UE 115 or its components as described with reference to FIGS. 1-14. For example, the operations of method 1600 may be performed by the TTI direction module 710 as described with reference to FIGS. 7-10. In some examples, a UE 115 may execute a set of codes to control the functional elements of the UE 115 to perform the functions described below. Additionally or alternatively, the UE 115 may perform aspects the functions described below using special-purpose hardware. The method 1600 may also incorporate aspects of method 1500 of FIG. 15.

At block 1605, the UE 115 may monitor for a grant during a first TTI of the second duration as described with reference to FIGS. 2-6. In certain examples, the operations of block 1605 may be performed by the grant module 805 as described with reference to FIG. 8.

At block 1610, the UE 115 may monitor for an indicator of a communication direction of a second TTI of the second duration as described with reference to FIGS. 2-6. In certain examples, the operations of block 1610 may be performed by the direction indication module 810 as described with reference to FIG. 8.

At block 1615, the UE 115 may receive the grant during the first TTI based at least in part on monitoring for the grant, wherein the communication direction of the second TTI is determined based at least in part on the received grant and a HARQ timing or UL scheduling timing as described with reference to FIGS. 2-6. In certain examples, the operations of block 1615 may be performed by the grant module 805 as described with reference to FIG. 8.

At block 1620, the UE 115 may determine the communication direction of the second TTI based at least in part on whether the indicator is received and whether the grant is received during the first TTI as described with reference to FIGS. 2-6. In certain examples, the operations of block 1620 may be performed by the direction determination module 815 as described with reference to FIG. 8.

At block 1625, the UE 115 may receive the indicator during the first TTI or a subsequent TTI based at least in part on monitoring for the indicator, and re-determining the communication direction of the second TTI based at least in part on the received indicator as described with reference to FIGS. 2-6. In certain examples, the operations of block 1625 may be performed by the direction determination module 815 as described with reference to FIG. 8.

In some examples of the method, the UE 115 may adapt the HARQ timing or the UL scheduling timing, or both, based on the received the indicator. The UE 115 may also determine that a duration comprises a guard period, where the guard period determination is based on the grant, HARQ timing, UL scheduling timing, or the indicator, or any combination thereof.

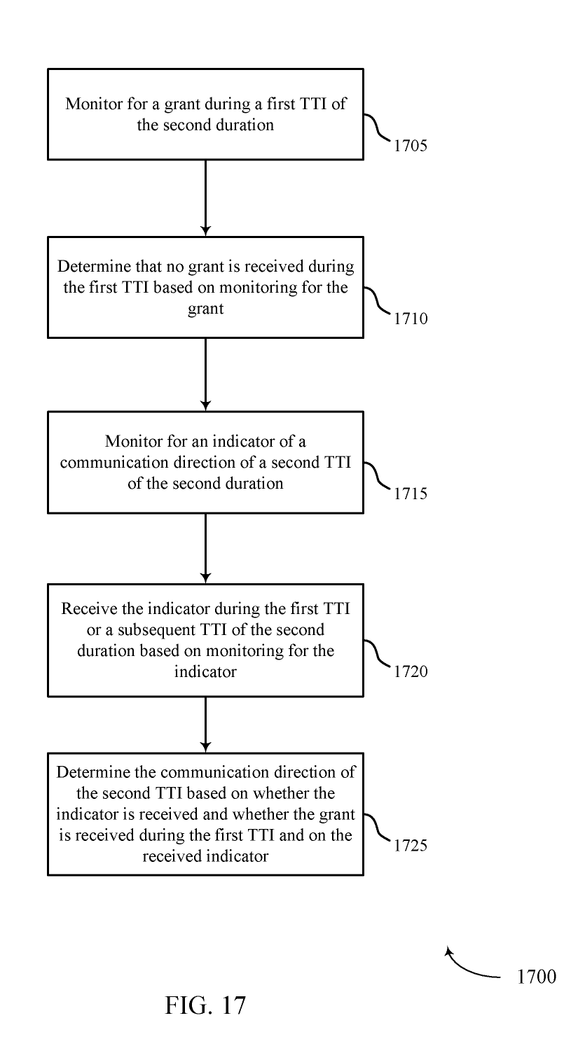

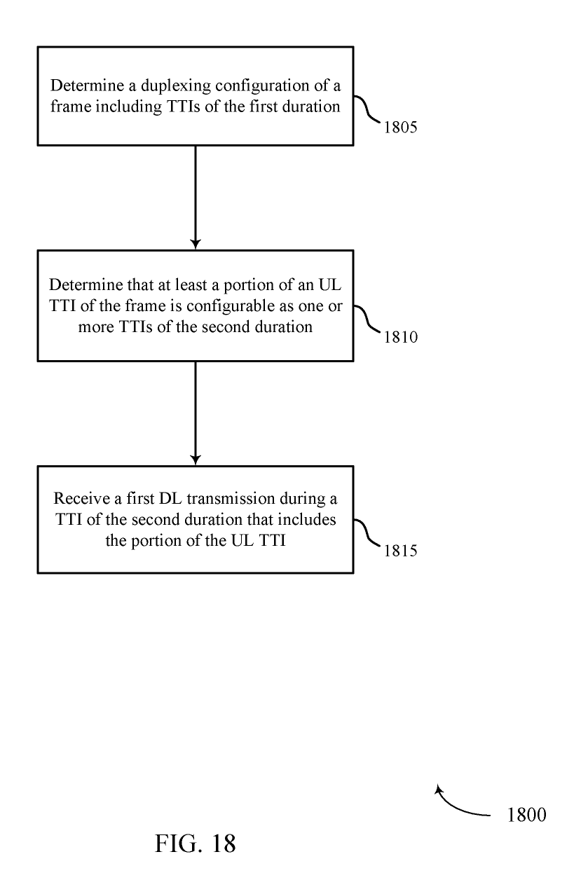

FIG. 17 shows a flowchart illustrating a method 1700 for low latency under TDD and flexible FDD in accordance with various aspects of the present disclosure. The operations of method 1700 may be implemented by a UE 115 or its components as described with reference to FIGS. 1-14. For example, the operations of method 1700 may be performed by the TTI direction module 710 as described with reference to FIGS. 7-10. In some examples, a UE 115 may execute a set of codes to control the functional elements of the UE 115 to perform the functions described below. Additionally or alternatively, the UE 115 may perform aspects the functions described below using special-purpose hardware. The method 1700 may also incorporate aspects of methods 1500, and 1600 of FIGS. 15-16.

At block 1705, the UE 115 may monitor for a grant during a first TTI of the second duration as described with reference to FIGS. 2-6. In certain examples, the operations of block 1705 may be performed by the grant module 805 as described with reference to FIG. 8.

At block 1710, the UE 115 may determine that no grant is received during the first TTI based at least in part on monitoring for the grant as described with reference to FIGS. 2-6. In certain examples, the operations of block 1710 may be performed by the grant module 805 as described with reference to FIG. 8.

At block 1715, the UE 115 may monitor for an indicator of a communication direction of a second TTI of the second duration as described with reference to FIGS. 2-6. In certain examples, the operations of block 1715 may be performed by the direction indication module 810 as described with reference to FIG. 8.

At block 1720, the UE 115 may receive the indicator during the first TTI or a subsequent TTI of the second duration based at least in part on monitoring for the indicator as described with reference to FIGS. 2-6. In certain examples, the operations of block 1720 may be performed by the direction indication module 810 as described with reference to FIG. 8.

At block 1725, the UE 115 may determine the communication direction of the second TTI based at least in part on whether the indicator is received and whether the grant is received during the first TTI as described with reference to FIGS. 2-6. In some cases, the communication direction of the second TTI is determined based at least in part on the received indicator. In some examples, UE 115 may refrain from monitoring at least one TTI of the second TTI duration based on the received indicator and the determined communication direction of the second TTI. In certain examples, the operations of block 1725 may be performed by the direction determination module 815 as described with reference to FIG. 8.

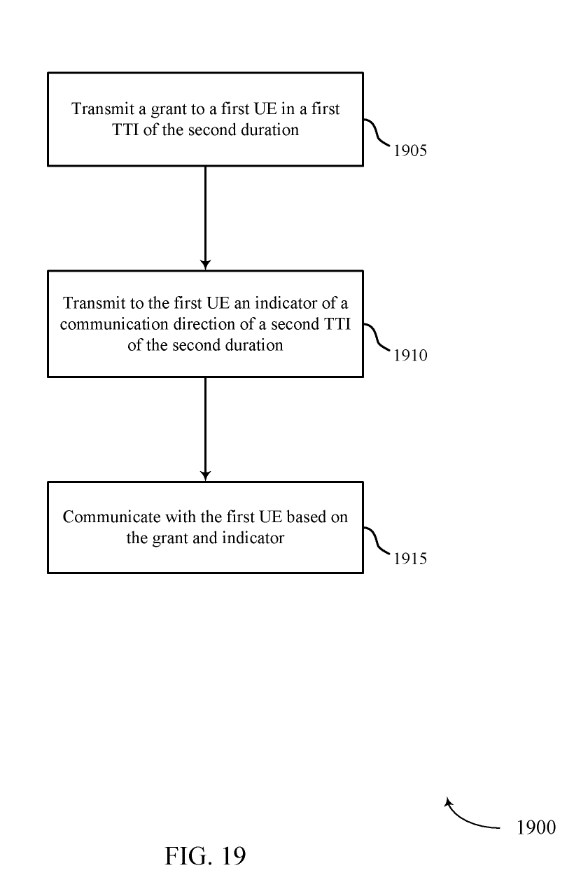

FIG. 18 shows a flowchart illustrating a method 1800 for low latency under TDD and flexible FDD in accordance with various aspects of the present disclosure. The operations of method 1800 may be implemented by a UE 115 or its components as described with reference to FIGS. 1-14. For example, the operations of method 1800 may be performed by the TTI direction module 710 as described with reference to FIGS. 7-10. In some examples, a UE 115 may execute a set of codes to control the functional elements of the UE 115 to perform the functions described below. Additionally or alternatively, the UE 115 may perform aspects the functions described below using special-purpose hardware. The method 1800 may also incorporate aspects of methods 1500, 1600, and 1700 of FIGS. 15-17.

At block 1805, the UE 115 may determine a duplexing configuration of a frame that includes TTIs of the first duration as described with reference to FIGS. 2-6. In certain examples, the operations of block 1805 may be performed by the duplexing module 920 as described with reference to FIG. 9.

At block 1810, the UE 115 may determine that at least a portion of an UL TTI of the frame is configurable as one or more TTIs of the second duration as described with reference to FIGS. 2-6. In certain examples, the operations of block 1810 may be performed by the flexible TTI module 925 as described with reference to FIG. 9.

At block 1815, the UE 115 may receive a first DL transmission during a TTI of the second duration that includes the portion of the UL TTI as described with reference to FIGS. 2-6. In certain examples, the operations of block 1815 may be performed by the receiver 705 as described with reference to FIG. 7.

FIG. 19 shows a flowchart illustrating a method 1900 for low latency under TDD and flexible FDD in accordance with various aspects of the present disclosure. The operations of method 1900 may be implemented by a base station 105 or its components as described with reference to FIGS. 1-14. For example, the operations of method 1900 may be performed by the base station TTI direction module 1110 as described with reference to FIGS. 11-14. In some examples, a base station 105 may execute a set of codes to control the functional elements of the base station 105 to perform the functions described below. Additionally or alternatively, the base station 105 may perform aspects the functions described below using special-purpose hardware. The method 1900 may also incorporate aspects of methods 1500, 1600, 1700, and 1800 of FIGS. 15-18.

At block 1905, the base station 105 may transmit a grant to a first UE in a first TTI of the second duration as described with reference to FIGS. 2-6. In certain examples, the operations of block 1905 may be performed by the BS grant module 1205 as described with reference to FIG. 12.

At block 1910, the base station 105 may transmit to the first UE an indicator of a communication direction of a second TTI of the second duration as described with reference to FIGS. 2-6. In some examples, the indicator may be transmitted during the first TTI or a subsequent TTI. In certain examples, the operations of block 1910 may be performed by the BS direction indication module 1210 as described with reference to FIG. 12.

At block 1915, the base station 105 may communicate with the first UE based at least in part on the grant and the indicator as described with reference to FIGS. 2-6. In certain examples, the operations of block 1915 may be performed by the receiver 1105 as described with reference to FIG. 11.

The method may also include base station 105 determining a traffic condition of the first UE and a second UE within the system and transmitting the indicator based on traffic associated with the first UE or the second UE.

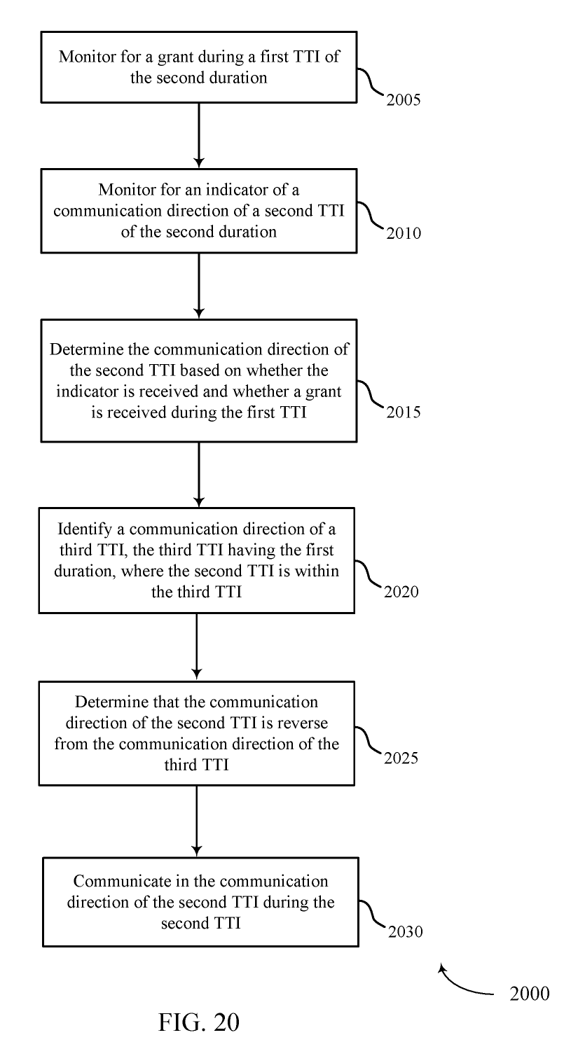

FIG. 20 shows a flowchart illustrating a method 2000 for low latency under TDD and flexible FDD in accordance with various aspects of the present disclosure. The operations of method 2000 may be implemented by a UE 115 or base station 105 or its components as described with reference to FIGS. 1-14. For example, the operations of method 2000 may be performed by the base station TTI direction module 1110 as described with reference to FIGS. 11-14. In some examples, a UE 115 or base station 105 may execute a set of codes to control the functional elements of the UE 115 or base station 105 to perform the functions described below. Additionally or alternatively, the UE 115 or base station 105 may perform aspects the functions described below using special-purpose hardware. The method 2000 may also incorporate aspects of methods 1500, 1600, 1700, 1800, and 1900 of FIGS. 15-19.

At block 2005, the UE 115 may monitor for a grant during a first TTI of the second duration as described with reference to FIGS. 2-6. In certain examples, the operations of block 2005 may be performed by the grant module 805 as described with reference to FIG. 8.

At block 2010, the UE 115 may monitor for an indicator of a communication direction of a second TTI of the second duration as described with reference to FIGS. 2-6. In certain examples, the operations of block 2010 may be performed by the direction indication module 810 as described with reference to FIG. 8.

At block 2015, the UE 115 may determine the communication direction of the second TTI based at least in part on whether the indicator is received and whether the grant is received during the first TTI as described with reference to FIGS. 2-6. In certain examples, the operations of block 2015 may be performed by the direction determination module 815 as described with reference to FIG. 8.

At block 2020, the UE 115 or base station 105 may identify a communication direction of a third TTI, the third TTI having the first duration, wherein the second TTI is within the third TTI, as described with reference to FIGS. 2-6. In certain examples, the operations of block 2020 may be performed by the dual communication module 1215 as described with reference to FIG. 12.

At block 2025, the UE 115 or base station 105 may determine that the communication direction of the second TTI is reverse from the communication direction of the third TTI, as described with reference to FIGS. 2-6. In certain examples, the operations of block 2025 may be performed by the dual communication module 1215 as described with reference to FIG. 12.

In some examples of the method, the UE 115 may communicate an indication of the presence of the second TTI within the third TTI, where the communication during the second TTI may be based on the indication. The UE 115 may also identify a duration within the third TTI, where the duration comprises a guard period. In some examples, the resources of the second TTI are frequency division multiplexing (FDM) with resources of the third TTI.

At block 2030, the UE 115 or base station 105 may communicate in the communication direction of the second TTI during the second TTI, as described with reference to FIGS. 2-6. In certain examples, the operations of block 2030 may be performed by the dual communication module 1215 as described with reference to FIG. 12.

Thus, methods 1500, 1600, 1700, 1800, 1900, and 2000 may provide for low latency under TDD and flexible FDD. It should be noted that methods 1500, 1600, 1700, 1800, 1900, and 2000 describe possible implementation, and that the operations and the steps may be rearranged or otherwise modified such that other implementations are possible. In some examples, aspects from two or more of the methods 1500, 1600, 1700, 1800, 1900, and 2000 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, Universal Mobile Telecommunications System (UMTS), LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means at least one of A, B, or C, or any combination thereof.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” “component,” and the like may not be a substitute for the word “means.” As such, no claim element is to be construed as a means plus function unless the element is expressly recited using the phrase “means for.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication in a system configured for operation with transmission time intervals (TTIs) of a first duration and TTIs of a second duration that is less than the first duration, comprising:
monitoring for a grant during a first TTI of the second duration;
monitoring for an indicator of a communication direction of a second TTI of the second duration;
determining the communication direction of the second TTI based at least in part on whether the indicator is received and whether the grant is received during the first TTI; and
communicating during the second TTI based on the determined communication direction.

2. The method of claim 1, further comprising:
receiving the grant during the first TTI based at least in part on monitoring for the grant, wherein the communication direction of the second TTI is determined based at least in part on the received grant and a hybrid automatic repeat request (HARQ) timing or uplink (UL) scheduling timing.

3. The method of claim 2, further comprising:
receiving the indicator during the first TTI or a subsequent TTI based at least in part on monitoring for the indicator; and
re-determining the communication direction of the second TTI based at least in part on the received indicator.

4. The method of claim 3, further comprising:
adapting the HARQ timing or the UL scheduling timing, or both, based at least in part on receiving the indicator.

5. The method of claim 2, further comprising:
determining that a duration comprises a guard period based at least in part on the grant, HARQ timing, UL scheduling timing, or the indicator, or any combination thereof.

6. The method of claim 1, further comprising:
receiving the indicator during the first TTI or a subsequent TTI of the second duration based at least in part on monitoring for the indicator;
determining that no grant is received during the first TTI based at least in part on monitoring for the grant; and
wherein the communication direction of the second TTI is determined based at least in part on the received indicator.

7. The method of claim 6, further comprising:
refraining from monitoring at least one TTI of the second duration based at least in part on the received indicator and the determined communication direction of the second TTI.

8. The method of claim 1, wherein the indicator comprises a physical control channel.

9. The method of claim 1, wherein the communication direction of the second TTI is determined based at least in part on a carrier type, a subframe type, or reference signal time-domain pattern.

10. The method of claim 9, wherein the carrier type comprises of at least one of a carrier operated in a licensed spectrum or a carrier operated in a contention-based spectrum, and the subframe type comprises at least one of a multicast broadcast single frequency network (MBSFN) subframe, a special subframe, or a downlink subframe.

11. The method of claim 1, wherein the indicator designates a communication direction for a set of TTIs comprising the second TTI.

12. The method of claim 11, further comprising:
receiving the indicator in the first TTI based at least in part on monitoring for the indicator, wherein the set of TTIs comprises a third TTI of the second duration after the second TTI.

13. The method of claim 1, further comprising:
identifying a communication direction of a third TTI, the third TTI having the first duration, wherein the second TTI is within the third TTI;
determining that the communication direction of the second TTI is reverse from the communication direction of the third TTI; and
communicating in the communication direction of the second TTI during the second TTI.

14. The method of claim 13, further comprising:
communicating an indication of a presence of the second TTI within the third TTI, wherein the communication during the second TTI is based at least in part on the indication.

15. The method of claim 13, further comprising:
identifying a duration within the third TTI, wherein the duration comprises a guard period.

16. The method of claim 13, wherein resources of the second TTI are frequency division multiplexing (FDM) with resources of the third TTI.

17. A method of wireless communication in a system configured for operation with transmission time intervals (TTIs) of a first duration and TTIs of a second duration that is less than the first duration, comprising:
transmitting a grant to a first user equipment (UE) in a first TTI of the second duration;
transmitting to the first UE an indicator of a communication direction of a second TTI of the second duration; and
communicating with the first UE based at least in part on the grant and the indicator.

18. The method of claim 17, further comprising:
determining a traffic condition of the first UE and a second UE within the system; and
transmitting the indicator based at least in part on traffic associated with the first UE or the second UE.

19. The method of claim 17, wherein the indicator is transmitted during the first TTI or a subsequent TTI.

20. An apparatus for wireless communication in a system configured for operation with transmission time intervals (TTIs) of a first duration and TTIs of a second duration that is less than the first duration, comprising:
a processor;
memory in electronic communication with the processor; and
instructions stored in the memory and operable, when executed by the processor, to cause the apparatus to:
monitor for a grant during a first TTI of the second duration;
monitor for an indicator of a communication direction of a second TTI of the second duration;
determine the communication direction of the second TTI based at least in part on whether the indicator is received and whether the grant is received during the first TTI; and
communicate during the second TTI based on the determined communication direction.

21. The apparatus of claim 20, wherein the instructions are operable to cause the apparatus to:
receive the grant during the first TTI based at least in part on monitoring for the grant, wherein the communication direction of the second TTI is determined based at least in part on the received grant and a hybrid automatic repeat request (HARQ) timing or uplink (UL) scheduling timing.

22. The apparatus of claim 21, wherein the instructions are operable to cause the apparatus to:
receive the indicator during the first TTI or a subsequent TTI based at least in part on monitoring for the indicator; and
re-determine the communication direction of the second TTI based at least in part on the received indicator.

23. The apparatus of claim 20, wherein the instructions are operable to cause the apparatus to:
receive the indicator during the first TTI or a subsequent TTI of the second duration based at least in part on monitoring for the indicator;
determine that no grant is received during the first TTI based at least in part on monitoring for the grant; and
wherein the communication direction of the second TTI is determined based at least in part on the received indicator.

24. The apparatus of claim 23, wherein the instructions are operable to cause the apparatus to:
refrain from monitoring at least one TTI of the second duration based at least in part on the received indicator and the determined communication direction of the second TTI.

25. The apparatus of claim 20, wherein the instructions are operable to cause the apparatus to:
identify a communication direction of a third TTI, the third TTI having the first duration, wherein the second TTI is within the third TTI;
determine that the communication direction of the second TTI is reverse from the communication direction of the third TTI; and
communicate in the communication direction of the second TTI during the second TTI.

26. The apparatus of claim 25, wherein the instructions are operable to cause the apparatus to:
communicate an indication of a presence of the second TTI within the third TTI, wherein the communication during the second TTI is based at least in part on the indication.

27. The apparatus of claim 25, wherein the instructions are operable to cause the apparatus to:
identify a duration within the third TTI, wherein the duration comprises a guard period.

28. An apparatus for wireless communication in a system configured for operation with transmission time intervals (TTIs) of a first duration and TTIs of a second duration that is less than the first duration, comprising:
a processor;
memory in electronic communication with the processor; and
instructions stored in the memory and operable, when executed by the processor, to cause the apparatus to:
transmit a grant to a first user equipment (UE) in a first TTI of the second duration;
transmit to the first UE an indicator of a communication direction of a second TTI of the second duration; and
communicate with the first UE based at least in part on the grant and the indicator.

29. The apparatus of claim 28, wherein the instructions are operable to cause the apparatus to:
determine a traffic condition of the first UE and a second UE within the system; and
transmit the indicator based at least in part on traffic associated with the first UE or the second UE.

30. The apparatus of claim 28, wherein the indicator is transmitted during the first TTI or a subsequent TTI.
